(19) United States
(12) Patent Application Publication
(10) Pub. No.: US 2025/0292697 A1
(43) Pub. Date: Sep. 18, 2025

(54) MECHANISM FOR ENSURING DRAGGABLE ENTRY CHOICES FALL WITHIN ESTABLISHED ERROR CATEGORIES

(71) Applicant: Rodney Adrain Weems, Bethlehem, PA (US)

(72) Inventor: Rodney Adrain Weems, Bethlehem, PA (US)

(21) Appl. No.: 19/077,762

(22) Filed: Mar. 12, 2025

Related U.S. Application Data
(60) Provisional application No. 63/565,088, filed on Mar. 14, 2024.

(51) Int. Cl. G09B 5/12; G06F 3/04817; G06F 3/04845; G09B 5/02

(52) U.S. Cl. CPC G09B 5/12; G06F 3/04817; G06F 3/04845; G09B 5/02

(57) ABSTRACT

A system makes the abstract, step-by-step logic of math problems visible via the use of digitized mathematical reasoning blocks, which can be used to construct an interactive teaching program that allows a student to select problem sets from an index of problems, allows the student to view a brief instructional video pertaining to that skill if desired, allows the student to choose the mode of problem presentation (i.e., various learning or test modes), allows the student to work randomly generated problems from within the chosen mode and set by dragging and dropping inputs to mathematical reasoning blocks that represent the various necessary/possible sub-steps in route to the solution of that problem.

### CROSS-REFERENCE TO RELATED APPLICATIONS

This application claims the benefit of the filing date of U.S. provisional application No. 63/565,088, filed on Mar. 14, 2024, the teachings of which are incorporated herein by reference in their entirety.

### BACKGROUND

### Field of the Disclosure

The present disclosure relates to machine-implemented techniques for teaching problem-solving in the areas of pre-algebra, algebra, and other math subjects.

### Description of the Related Art

This section introduces aspects that may help facilitate a better understanding of the disclosure. Accordingly, the statements of this section are to be read in this light and are not to be understood as admissions about what is prior art or what is not prior art.

Math reasoning blocks have proven effective for teaching math to low-performing students in need of individualized instruction. A central element of this effectiveness is the ability of math reasoning block systems to track step-level errors via established categories that fall along lines of student errors in understanding. Unfortunately, the system has been effective only on computer screens equal in size to or larger than a tablet. Yet, most screens in the hands of teenagers today are mobile phones, which are smaller than that.

According a 2019 report by the marketing agency Fuse, phones are teen's favorite electronic device. Research cited in Fortune magazine found that they spend most of their time on their phones, alone, “in their bedrooms . . . ” In other words, phones are highly accessible in the teen population and phone use is highly habituated in that population.

### SUMMARY

The present disclosure relates generally to a method of making math reasoning blocks more broadly effective for teaching problem-solving in the areas of pre-algebra, algebra, and other math subjects whose step-by-step solutions can be formally governed by an established set of axioms and theorems. More specifically, this disclosure is related to extending the functionality of math reasoning blocks so that they are a) more effective for math instruction on mobile phone and other low-real-estate screens and b) more user friendly for students with various learning challenges that make typing or auto-pasting difficult or impossible options for inputting answers at each step of a problem.

The specific method of accomplishing this and the focus of this mechanism is ensuring draggable entry choices fall within established error categories. This mechanism may be used in any system where it is highly desirable to track correct and incorrect answers based on the categories characterizing those wrong answers. But it is necessitated by the need to extend the procedural, step-level, error-category tracking that is central to the unique functionality of mathematical reasoning blocks.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIGS. 1A-1C are block diagrams of three different architectures for implementing the present disclosure;

FIG. 2 is a workflow diagram of one possible implementation of the present disclosure;

FIGS. 3A-3J are screen displays for an example algebra simplification problem of the present disclosure;

FIGS. 4A-4N are screen displays for an example word problem of the present disclosure;

FIGS. 5A-5G are screen displays for an example graphing problem of the present disclosure;

FIG. 6 is a representation of one possible table for recording step-level error statistics of the present disclosure;

FIG. 7 is an example of how several individual coded methods might be combined to generate a set of non-arbitrary wrong answers; and

FIG. 8 is an example table of the types of mathematical error categories reasoning blocks are dedicated to tracking.

### DETAILED DESCRIPTION

Reference herein to “one embodiment” or “an embodiment” means that a particular feature, structure, or characteristic described in connection with the embodiment can be included in at least one embodiment disclosed and claimed herein. The appearances of the phrase “in one embodiment” in various places in the specification are not necessarily all referring to the same embodiment, nor are separate or alternative embodiments necessarily mutually exclusive of other embodiments. The same applies to the term “implementation.”

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

Firefallmath.com—by Firefall Math LLC, Bethlehem, PA—is an online resource that facilitates teaching math students prealgebra and algebra. It utilizes an embodiment of the “System and Methods Using Mathematical Reasoning Blocks” (U.S. Pat. No. 10,460,615 B2, the teachings of which are incorporated herein by reference in their entirety) to accomplish this task. As described therein, mathematical reasoning blocks are computerized block-like images that are used as visible markers for mathematical axioms, theorems, and procedural functions. When solving any Firefall math problem, users drag in the block that describes the reason (axiom, theorem, or procedural identifier) for each step they are about to perform.

Numerous educational benefits characterize this system. Among the most important is the system's ability to identify and track student errors at the individual step-level and to record them in categories that parallel the step-level reasoning where the error occurred. This is useful information for a teacher to have because students almost never misunderstand entire problems. Instead, they tend to misunderstand a single skill-level step in such problems and to misunderstand that skill in a particular way. A math-reasoning block system's ability to identify the step where a misunderstanding lies and supplying students and teachers with step-level information to facilitate the quick correction of those misunderstandings are, therefore, educationally invaluable.

If Firefall's math reasoning blocks could be adapted for a phone-sized device that is more readily accessible and more widely used than their larger-screened counterparts (while simultaneously preserving their error checking/tracking functionality), it would be a sea-change in terms of extending the reach and educational benefits of math reasoning blocks, especially for at-risk groups who, PEW research shows, have the highest small-screen access rates.

Beyond making math reasoning blocks far easier for the general public to work with on small screens, this new method will also help students with disabilities that limit their ability to input reasoning block answers by typing or auto-pasting. These students are disadvantaged by current reasoning block systems even on large screens. Currently, the limiting factor is the requirement that reasoning block users must show their work at every step in the problem-solving process. Modifying a reasoning block system so that students with disabilities can significantly reduce or eliminate the need to type in or auto-paste entries at almost every step provides the second rational for having developed this system.

The mechanism described herein is necessitated by the need to extend the procedural, step-level, error-category tracking of FIG. 8 that is central to the unique functionality of mathematical reasoning blocks so that they can be used in small screen environments or by children with special learning needs.

Various embodiments disclosed herein are directed at creating a mechanism for ensuring that draggable entry choices in a mathematical reasoning block system fall within established error categories. This will allow us to create an interactive, computerized, learning environment that overcomes the current data-entry shortcomings of mathematical reasoning blocks in small-screen-size environments and where student disabilities limit the usefulness of typed or auto-pasted input during problem-solving exercises.

This summary of some embodiments is divided into two parts. The first portion involves the mechanism for ensuring that draggable entry choices fall within established error categories.

The second portion of this summary involves a description of some possible reasoning block systems that can be built once such a mechanism exists.

Regarding the first portion of such a system, the way in which the alpha-numeric data that will populate the draggable-elements section is generated is central to the functioning of an embodiment of this proposed system. In one such embodiment, the correct answer would be mixed in with numerous randomly-generated answers. Incorrect, randomly-generated answers will fail to maximize the pedagogical effectiveness of math reasoning blocks.

A preferred embodiment would, instead, populate the draggable-elements section with one or more correct answers or portions of a correct answer and a number of specially generated incorrect answers that typify high-percentage errors made by students employing the particular operational skill being performed in that step.

In preferred embodiments, the correct answer or answer portions would be generated by a coded method designed to generate the correct answer or answer portions at each step.

The incorrect answers or answer portions could be generated in any number of ways depending on the embodiment. In a preferred embodiment of this system, a single, individual method would be assigned and coded to generate a set of one or more wrong answers for each one of the possible categories of typical mistakes that characterize a given step.

If there are two possible error categories in a step, two methods would be coded to perform an errant simplification of the prior step in ways that are characteristic of each of the two categories of errant understanding. If three possible error categories existed at a step, then three dedicated methods would be coded to handle generating the associated sets of errors. And so on.

In some embodiments of this system, another coded method would then select at least one answer from each set of generated wrong answers, adding them to memory, along with the correct answer(s). In a preferred embodiment, more than one answer might be selected from each category, if required to fully populate the draggable-answers section of the proposed system.

In some preferred embodiment of this system, fairly simple correct and incorrect step-level answers (like the resulting “8” after adding 2-1+7) might lack sufficient sub-parts to allow them to be broken into pieces. But, in more complex steps, a preferred embodiment should include a systematic method of subdividing the right and wrong answers, eliminating repeat sub-parts, and placing a portion of the remaining parts in the draggable-answers section so that the user could then select them to construct both correct and reasonable incorrect step-level answers in the work area.

Given advancements in artificial intelligence, it is now possible at a given step that some embodiments of this system could use multiple prompts or a single, detailed prompt to an AI system to generate correct and incorrect answers satisfying the requirements outlined in paragraphs [0028] through [0032].

Generating the non-alpha-numeric-symbolic correct and incorrect answers, basically the correct and incorrect reasoning blocks available at any given step of such a system, is easier than generating the alpha-numeric-symbolic correct and incorrect answers. In a preferred embodiment of such a system, the blocks to be stacked as draggable possibilities in the draggable-elements section can be determined by coding a method to decide the next correct reasoning block or blocks in the current problem-solving step. Then a selection of the remaining available reasoning blocks can be added to that block or blocks to form the possible block choices for the current step.

In a preferred embodiment of such a system, the blocks would be displayed in the draggable-elements section in groups. A selection of a portion of the numeric blocks would be displayed horizontally in one group. The same with the word blocks in another group and the picture blocks in still another group.

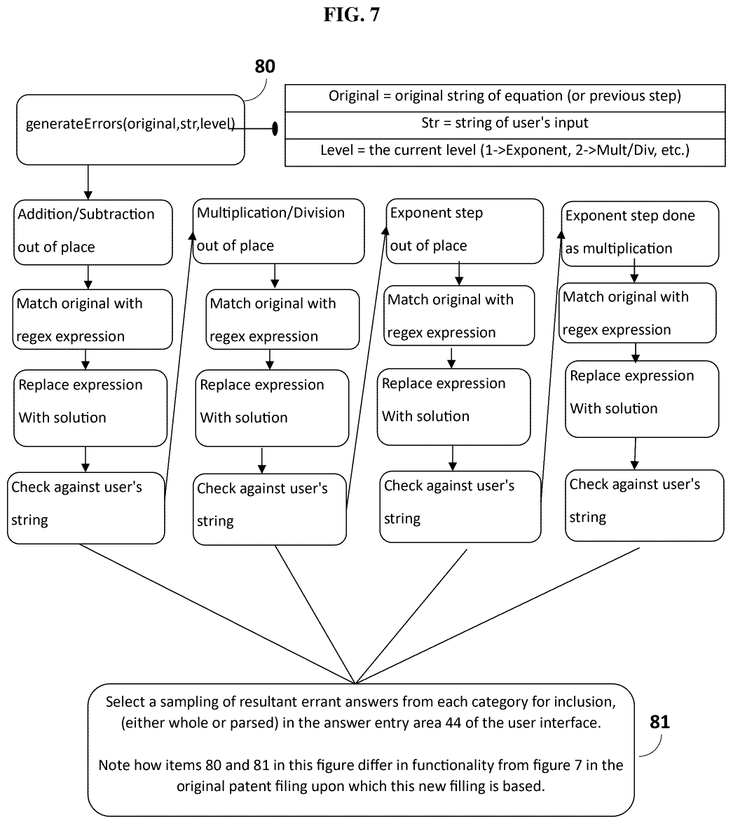

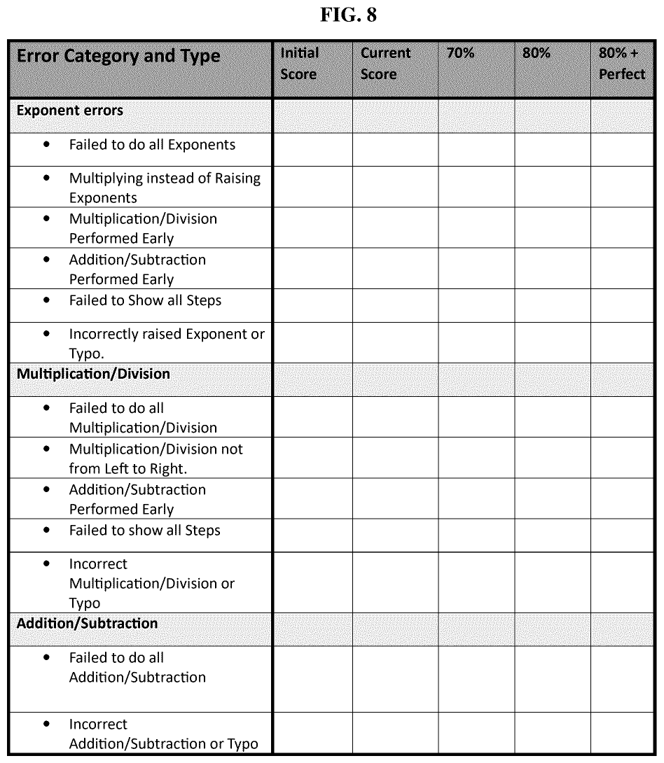

In combination, this is an example of an embodiment of the first portion of a mechanism for ensuring that draggable entry choices fall within the established error categories associated with each step of a problem. Examples of how some of the error icons might be generated and how they might be categorized in such a system are illustrated in FIG. 7 and FIGS. 6 and 8.

In an embodiment of the second portion of such a system, the user interface associated with the system will comprise three separate sections. An initial alpha-numeric-symbolic phrase, sentence, or problem to be simplified or solved will be presented at the top of this first section, the workspace section. In addition to displaying the initial problem, this workspace section will be configured to receive droppable, typed, or auto-pasted input.

A second section called the draggable-elements section will rest below the workspace. It will house a set of draggable elements. Sometimes those draggable elements will represent the names of axioms and theorems necessary to justify the next step of the problem.

At other times and in some embodiments, those elements will be draggable versions of the correct answer or various plausible wrong answers for that step. In other embodiments, those draggable elements might be pieces of the correct answer mixed in with pieces of various incorrect answers, from which the correct answer for that step can be assembled. In still other embodiments, those draggable elements might be a mixture of these two possibilities.

In embodiments similar to the ones presented here, the final section, the check-button section, will rest below the draggable-elements area. When the check button in this section is pressed, it will cause the system to check if the blocks that have been dragged and dropped into the work area form the correct answer for that step.

In a preferred embodiment of this new system, the user will solve the problem exclusively by selecting and dragging in some combination of a succession of draggable-elements that appear inside the draggable-elements section.

In one possible embodiment of this system, pressing the check button will trigger the system to check the correctness of the entry the user has constructed by dragging in one or more draggable blocks into the work area.

In some embodiments of this system, when an incorrect axiom or theorem title-element is dragged into the work area, it will automatically return to its original position in the draggable-elements section if the selected block is incorrect for that step.

In other embodiments, when an incorrect axiom or theorem title-element is dragged into the work area, it will remain in the position it was dropped until removed.

In addition, in some embodiments, a box may appear with an error message that hints at a more appropriate block choice will appear.

In one preferred embodiment of this system, each of these three elements can be used separately or in combination as appropriate to maximize student engagement and learning.

When it comes time to drag in block elements that contain the alpha-numeric-symbolic input necessary to select or construct the correct algebraic answer for that step, in one preferred embodiment, all block portions of that answer will remain in the workspace unless the user decides to purposely drag a selected block or blocks back into the draggable-elements section. In other words, such an embodiment would contain no provision for indicating an errant answer until the check button had been pressed.

In other embodiments, it might be useful to have errant alpha-numeric-symbolic blocks float back if they fail to construct the correct answer for that step in left-to-right order.

In any given embodiment, the number of times a user will be allowed to place/construct a correct answer in the work area and check that answer with the check button will vary from one time to many times. In a preferred embodiment, the user will be given two chances to place/construct a correct answer. After a second wrong answer, the correct answer will be placed in the work area, an error message will be generated to explain why the user erred, and the draggable-elements section will be repopulated to allow the user to work on the next step.

This preferred embodiment—in which reasonable incorrect answers are mixed in with correct answers or reasonable incorrect- and correct-answer sub-parts—would continue to allow mathematical reasoning block systems to leverage one of their most important aspects, the ability to spot, record, and help users eliminate the typical misunderstandings associated with using various step-level axioms and theorems to solve a math problem.

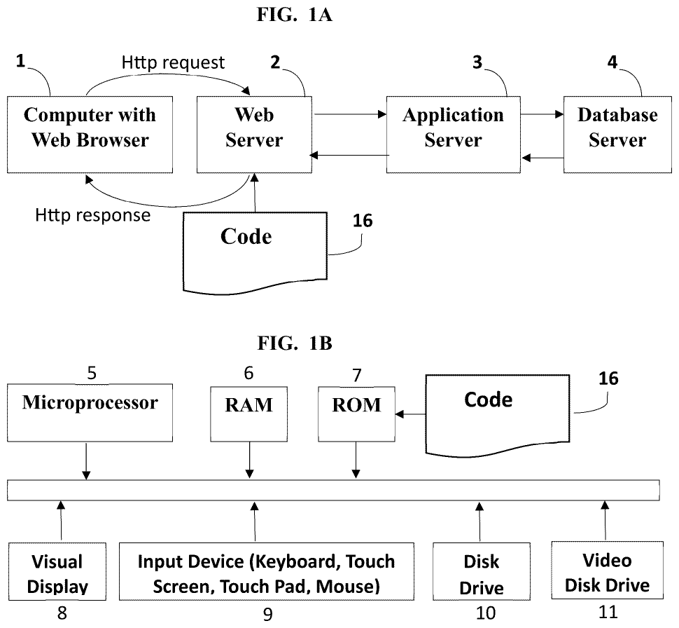

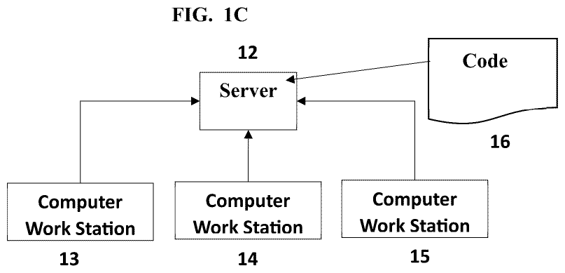

One embodiment of this disclosure may be an online system of FIG. 1A. This system may comprise a machine-based device 1 operating a web browser with client-side processing capabilities. A web server 2 containing a browser-compatible, code-based aspect of this embodiment may supply that aspect to the machine-based device 1, assisted by an application server 3 and a database server 4 used to store statistics long-term. The code 16 for this disclosure may be provided from memory (not shown).

This is only one embodiment among other possible embodiments. By way of example, stand-alone PC embodiments, as shown in FIG. 1B, and intranet embodiments, as shown in FIG. 1C, may also be used to allow use of an embodiment of this system.

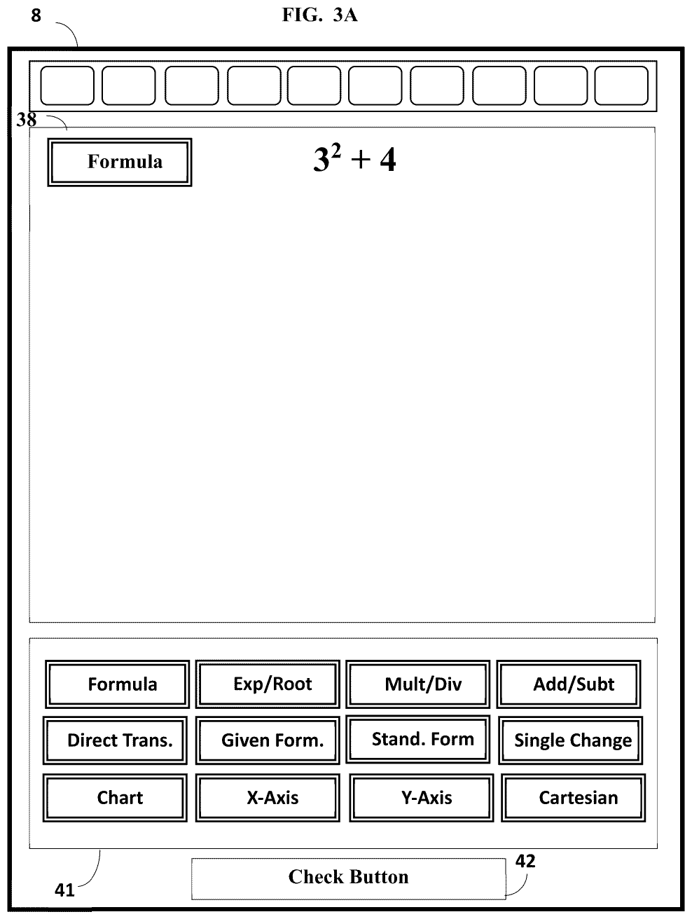

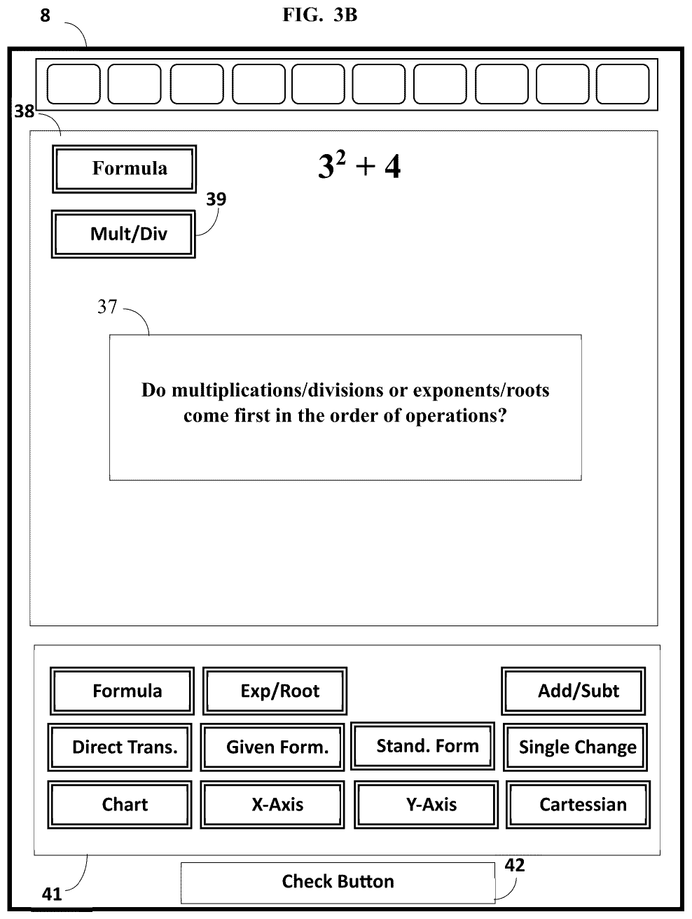

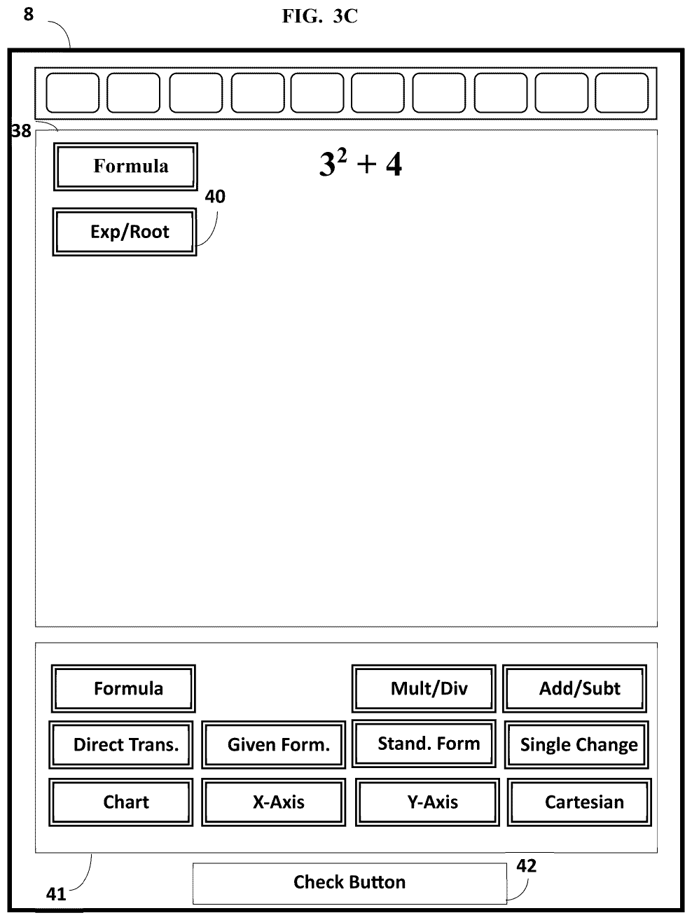

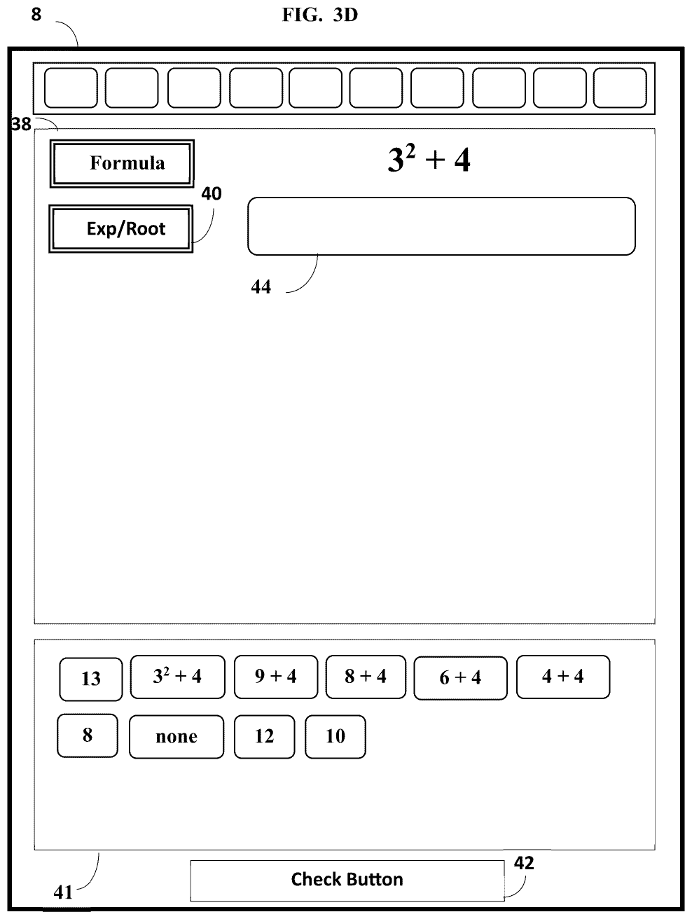

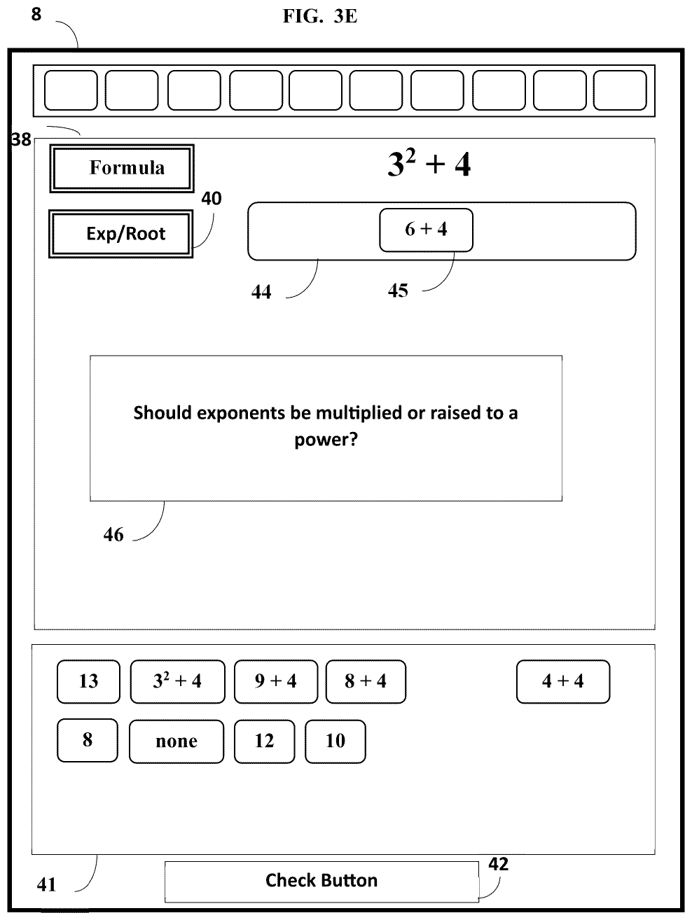

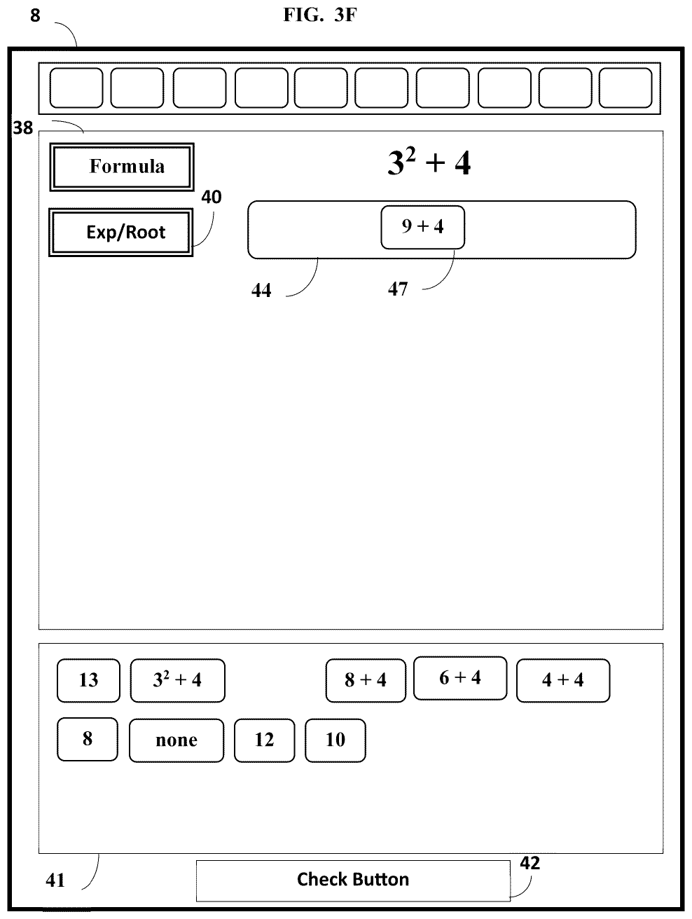

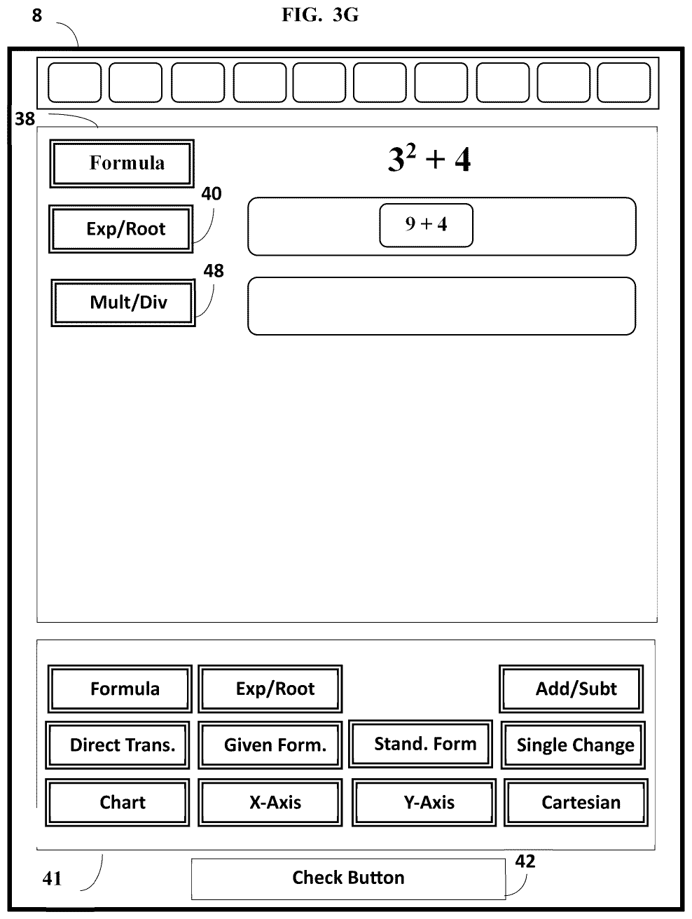

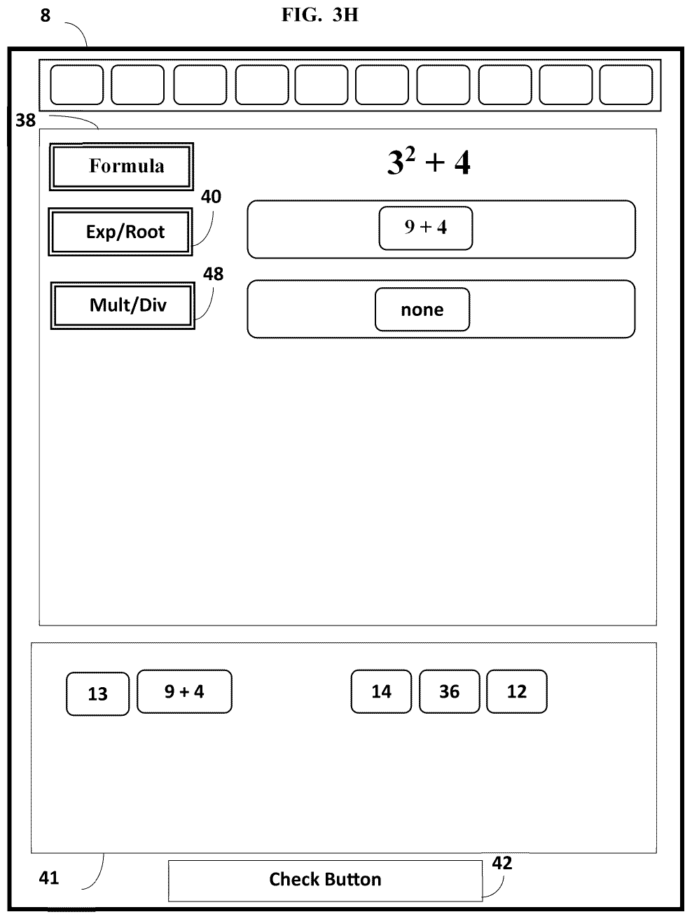

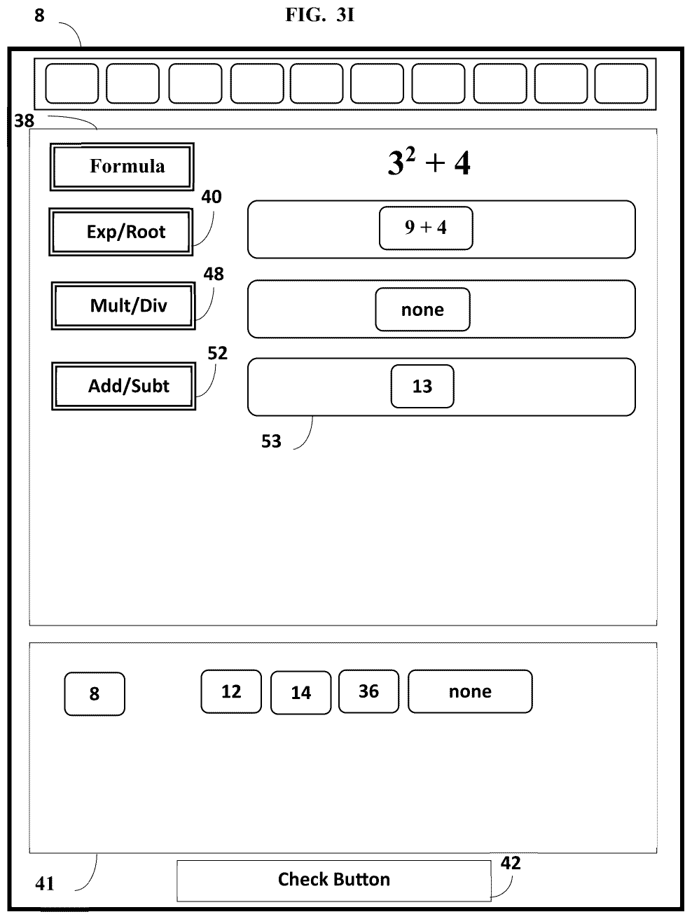

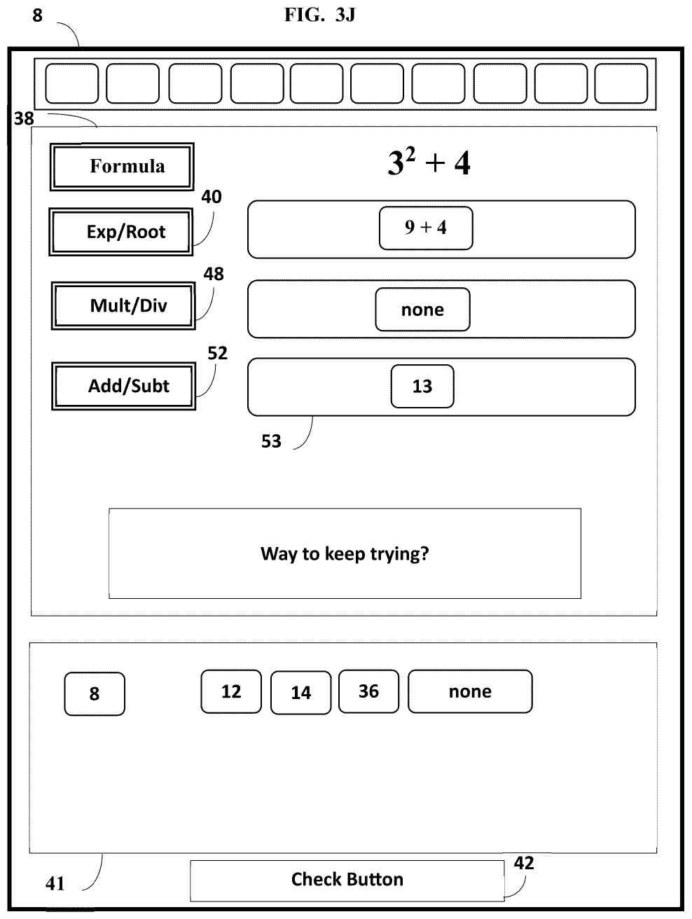

Referring back to FIG. 1A, a coded, interactive learning system 16 supplied by the web server 2 and in accordance with an aspect of this embodiment is shown in FIG. 1A. The online system 16, accessible via a web browser 1, may be configured to present an exercise such as the one illustrated in FIG. 3A.

As previously described, some embodiments can operate on a web-based platform, a standalone PC platform, or an intranet platform. An example of a standalone computer platform is shown in FIG. 1B. This off-line system may use a computerized device requiring no connection to the internet in order to use the embodiment. The computer's microprocessors 5, RAM 6, and ROM 7 may be used to run an offline version 16 of the software in accordance with the various aspects of the embodiment, with a visual display 8 available for viewing interface screens generated by this embodiment. This offline embodiment may also include an input device 9 such as a keyboard, touch screen, touch pad, or mouse. Other embodiments might include and use disk drives 10 or video disk drives 11 to facilitate the use of the embodiment.

In accordance with an aspect of another embodiment, a local area network as shown in FIG. 1C may be used to allow users access to one embodiment of the learning system described herein. The local area network server 12 executing code 16 and the networked computer work stations 13, 14, 15 may be used in combination with each other to supply the computational, memory, displays, and input elements that may be used in an embodiment.

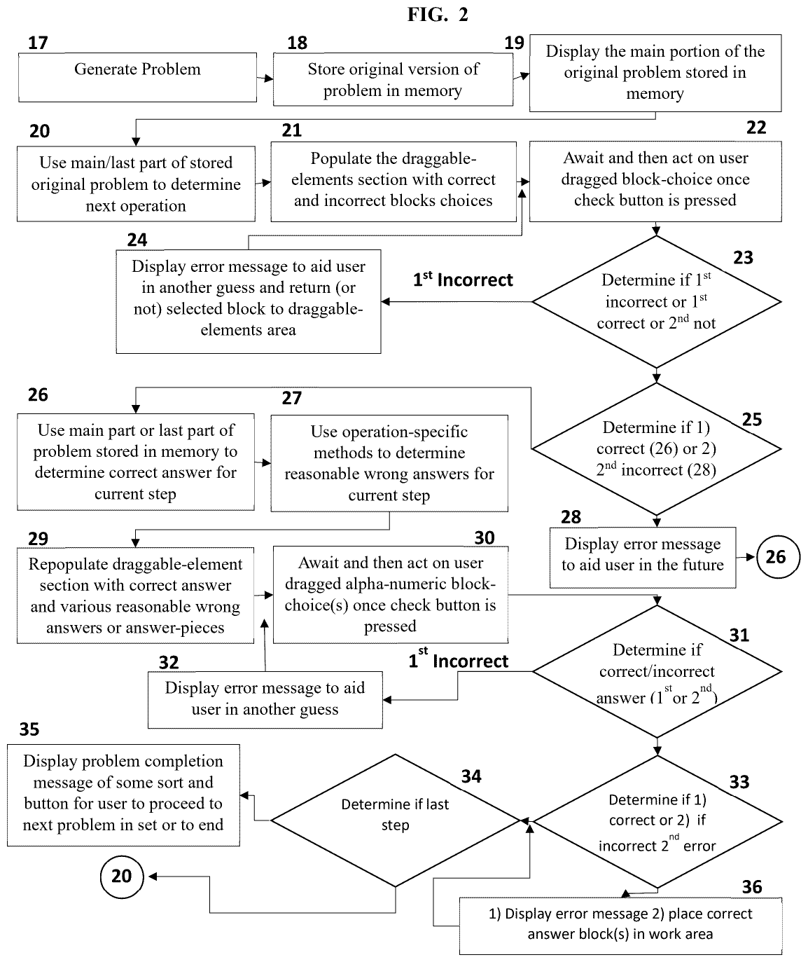

In one preferred embodiment of this program, the workflow will proceed along the path described by the flowchart in FIG. 2. For a given exercise, a problem will be generated that addresses a target skill. In some embodiments, each problem will be generated on an as-needed basis. In other embodiments, this problem may come from a pre-generated set and successive problems from that set will serve as the generated problem in step 17.

That problem will then be stored in memory in step 18. It may be stored by being instantiated in code 16, by residing in the cloud on a server 3 or 4 of FIG. 1A, by residing in RAM 6 or ROM 7 of FIG. 1B, or by being housed on an external memory device such as a disk drive 10 of FIG. 1B.

In some preferred embodiments the generated problem will then be displayed in step 19 on a computer with an open web browser 1 of FIG. 1A, or on a computer or workstation with a visual display 8 of FIG. 1B or 13 of FIG. 1C. This would take place in item 38 of FIG. 3A.

In one embodiment, in step 20, the code 16 of FIGS. 1A-1C will use the stored portion of the original problem to determine what the next operational step should be to solve the presented problem. For example, if the presented problem was 3\hat{ }2+4, then, in some embodiments, the next step would be an exponent step in this embodiment of a reasoning block system. Using another reasoning block example, if the presented problem was a word problem, then, in some embodiments, the code in step 20 would determine the type of word problem it is and the reasoning block that matches that type of problem.

In some preferred embodiments, in step 21, the code 16 will then populate the draggable elements section 41 of FIG. 3A with correct and incorrect block choices.

Continuing with the 3\hat{ }2+4 example, in some embodiments, the correct block for this portion of the workflow would be an exponent/root block. In other embodiments, the correct block might be an exponent block. In a preferred embodiment of this invention, the correct block would depend on the supply of blocks available for accomplishing the simplification or solving of problems. In some embodiments, at certain junctures, there may be more than one possible correct reasoning block to choose from, depending on how the user decides to proceed through the problem. Regardless, such virtual block sets should be sufficient to accomplish every step of whatever kind of problem is meant to be presented within such a reasoning block embodiment. The remaining incorrect blocks in this section 41 would be drawn from among the remaining blocks from that set.

In one embodiment, in step 22, the coded application would then await the user choosing a block from the now-populated draggable-elements section, dragging that choice into the work area 38, and pressing the check button 42 of FIG. 3A to see if that choice is correct.

Upon the check button being pressed, in some embodiments, following this workflow, in step 23, the code 16 will determine if the answer is correct or incorrect. In some embodiments, if the block choice is incorrect, then the code will also determine if this is the user's first attempt (in step 23) or second attempt (in step 25) at dragging in a correct block.

If the selected block is incorrect (item 39 of FIG. 3) and it is a user's first try, then, in step 24, some embodiments will display an error message (item 41 of FIG. 3B) to aid the user in another guess and the selected block will return to its original place in the draggable blocks section of step 22. In other embodiments, an error message will likewise occur, but, in step 24, the user will have to remove their errant block choice manually rather than having it automatically removed by coded automation.

If the selected block is incorrect and it is the user's second try, then in some embodiments, in step 28, an error message will be displayed explaining why the error occurred so the user will know for the next time and the correct block will appear in the correct place in the work area as determined by the code 16. The code 16 will then work to allow the user to move to the next step 26 in the workflow.

If the user's first or second block selection is correct, then the code will likewise work to allow the user to move to the next step 26 in the workflow.

Next comes the portion of the disclosure that outlines the most-critical elements that make a draggable data entry system for reasoning blocks not just possible to implement on a small screen or for typing-challenged students, but also useful in ensuring the system's novel skill-level error tracking sub-system can garner useful information for students' specific areas of understanding and misunderstanding for each step of a problem.

The steps in this section of the workflow include steps 26, 27, 29, and 30. In a preferred embodiment, these steps are concerned not just with generating the correct mathematical answer for the written portion of each step of a math problem 26, but, in particular, step 27 is concerned with generating errant steps that fall within each subset of typical math errors made by students in each of those steps. If random wrong answers were generated without paying sufficient attention to answers resulting from important, high-probability misunderstandings, there would be no reliable way to track those misunderstandings in students, which is a primary consideration of a preferred embodiment of a mathematical reasoning block system.

In some embodiments characterized by this workflow, one correct answer for this reasoning block step 26 in the problem will be generated. In some embodiments, multiple wrong answers will also be generated for this step 27. But, in preferred embodiments, these wrong answers will fall into categories of wrong answers typical of errant student answers for a given reasoning block step.

This ability to categorize answers and record them at the step level is critical to the effectiveness of mathematical reasoning blocks and, therefore, to the structure of this draggle-answers system for augmenting the older versions of these blocks. This is because the errors that students make are linked to the misunderstandings they have. Different misunderstandings tend to produce a different constellation of errors. Also, students tend not to misunderstand an entire large-scale algorithm. It is more likely that they misunderstand one step in that algorithm and that that one step is misunderstood in a unique but readily identifiable way. Providing the appropriate error categories and a system for spotting and categorizing those errors elements are at the heart of embodiments of this draggable-block system.

As an example of how such embodiments of this system might satisfy this requirement of step 27, suppose the following problem was presented: 2+5-4+1 in a system configured to handle only addition/subtraction. The correct answer, resulting from adding from left to right is 4. The typical categories of wrong answers for this step would be 1) choosing to do nothing due to misunderstanding or lack of effort, 2) performing only the additions (incomplete work), 3) performing only the subtractions (incomplete work), 4) performing the additions and then the subtractions, 5) making a slight addition error when performing the problem resulting in an answer one above or one below the correct answer. These would result in the following answers:
1) “none”,
2) “7-5”,
3) “2+1+1”
4) “2”
5) “5”.

In preferred embodiments structured around step 27, individual methods or code blocks would be dedicated to checking for and generating possible errant answers resulting from each type of misunderstanding or maladaptive method possessed of a reasonable probability of being employed by a user to supply an errant answer. In this example, these possible errant answers could then be mixed in with the correct answer for this problem and placed in the draggable-elements section 41 of FIG. 3A. At each reasoning-block step, one method per wrong-answer category can be allocated to generate many of the possible, typical, wrong answers characterizing that category. Wrong answers from all those methods can then be used to populate the draggable-elements section 41 in workflow step 29.

Additionally, a preferred embodiment would also generate partially-correct answers such as 7−4+1 and 3+1 for inclusion in the draggable block answers. The reason for including such partially-correct answers in some embodiments is that many math-challenged students cannot perform more than one operation in their heads at one time. Having answers that are wrong by virtue of being unfinished, allows them to be dragged in, one at a time, to represent each successive step in calculating that line's answer, until the correct answer is finally arrived at.

Some embodiments will break these answers down into smaller pieces that can then be used to construct a larger answer. But, if such an embodiment is instantiated, the code 16 will also have to ensure that there were no duplicate alpha-numeric pieces before placing the results in the draggable-elements section.

In some embodiments, once the draggable-elements section is populated, in step 30, the system will await the user's attempt at a) dragging in a correct answer or dragging in the blocks necessary to construct the correct answer and b) pressing the check button 42.

From here onward, the workflow is similar to the workflow when dragging in a reasoning block and checking to see if the selected block is correct. But, in this case, the system will check to see if the dragged-in alpha-numeric block of blocks for this step 31 represent the correct mathematical answer.

In some embodiments, if the dragged-in answer is correct, then the blocks will be accepted, and, in step 34, the system will check to see if this is the last step in the problem. If it is the last step, then, in some embodiments, in step 35, a congratulatory message will be displayed. In some embodiments, some number of points will be allocated for a correctly completed problem. In some embodiments, in step 35, the possibility exists for a next problem button to signal to the system to produce the next problem or to end the problem set if it is the last problem. In a preferred embodiment, multiple combinations of these possibilities will be employed.

In some embodiments, if, in step 33, the dragged-in answer is incorrect, then, in step 36, an error message will appear. In preferred embodiments, it will appear regardless of the number of attempts made at a correct answer by the user. In some embodiments, if it is the first wrong answer, then, after the error message is displayed, the user will be given another opportunity to construct the correct answer and press the check button in step 30.

If this is the second incorrect answer attempt, then, in some embodiments, in step 36, an error message will appear and the correct answer for this step will also appear. In some embodiments, the incorrect blocks will float out and the correct blocks will float in. In other versions, the incorrect blocks will fade out and the correct answer will fade it. In still other versions, other methods may be used to bring the correct answer to the fore.

In some embodiments, if the system determines, in step 34, that it is not the last step, then the system will return the user to step 20, where the system will set up the next step of the problem and allow the user to continue from there.

As just discussed, the workflow represented by FIG. 2 of a preferred embodiment of this draggable data-entry system comprises many steps. But, in a simplified summary, the workflow primarily comprises two, large-scale steps, each alternately repeated until the given problem is solved.

Large-scale step one allows users to pick the next reasoning block needed to justify the work they are about to do. In a preferred embodiment of this system, the draggable-elements area 41 will be populated with one correct reasoning block and multiple incorrect reasoning blocks for the user to choose from, as in FIG. 3A. The user can drag in their reasoning-block choice 40 FIG. 3C. Then the user can press the check button 42 to verify their choice is correct and proceed to the next step of FIG. 3D.

Large-scale step two allows the user to pick the draggable alpha-numeric-symbolic block or blocks needed to construct the proper answer for the now-visible answer-entry area 44 of the reasoning block chosen in the prior large-scale step. In a preferred embodiment of this system, the draggable-elements section will be populated with one correct alpha-numeric-symbolic block or set of blocks and a set of blocks that are incorrect or that will lead to the construction of an incorrect answer, as in draggable-elements area 41 of FIG. 3D. The user can drag into the answer-entry area 44 the block or blocks representing their attempt at a correct alpha-numeric-symbolic answer to that step 45 of FIG. 3E. Then the user can press the check button 42 to verify their choice is correct, as in FIG. 3E.

In a preferred embodiment of this system, if the user completes every step of the problem-solving process correctly, items 40, 48, 52 in FIG. 31 and their associated entry areas, like 53, these two steps will alternate in lockstep until the problem is complete. But, when an error is made in either large-scale step, each of the coded systems will give the user one more chance to correctly complete that step.

In this portion of the example of FIG. 3B, the user tried to drag in a “Mult/Div” block 39. But, because the user should have tried to deal with the exponents in the problem first, when they press the check button 42, an error message 37 results. The user can now drag out the incorrect reasoning block and drag in the correct one 40 of FIG. 3C. Pressing the check button 42 will then bring us to the second large-scale step in this two-step process, as in FIG. 3D.

Similarly, if an error is made on this second large-scale step, as in FIG. 3E, in this case by dragging in the “6+4” alpha-numeric-symbolic block 45, an error message will appear, as in 46 of FIG. 3E. Then the user will again be given a second chance to repeat this large-scale step by entering a correct answer 47 of FIG. 3F.

From there on out, this same two-step pattern repeats until the end, given that no other mistakes are made. In this example, these large-scale paired steps happen in FIGS. 3G and 3H, and one last time in FIGS. 31 and 3J.

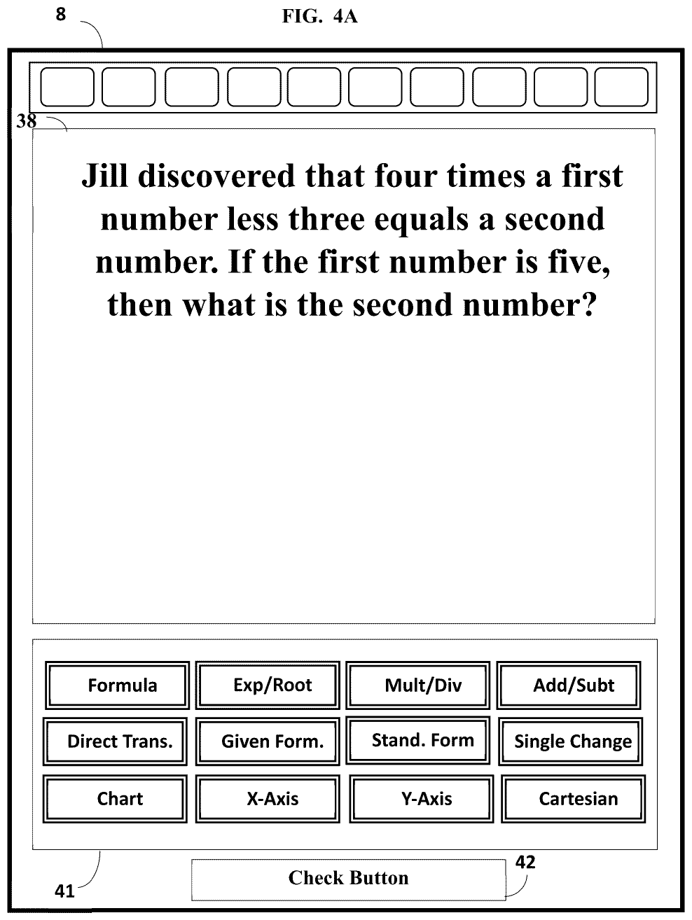

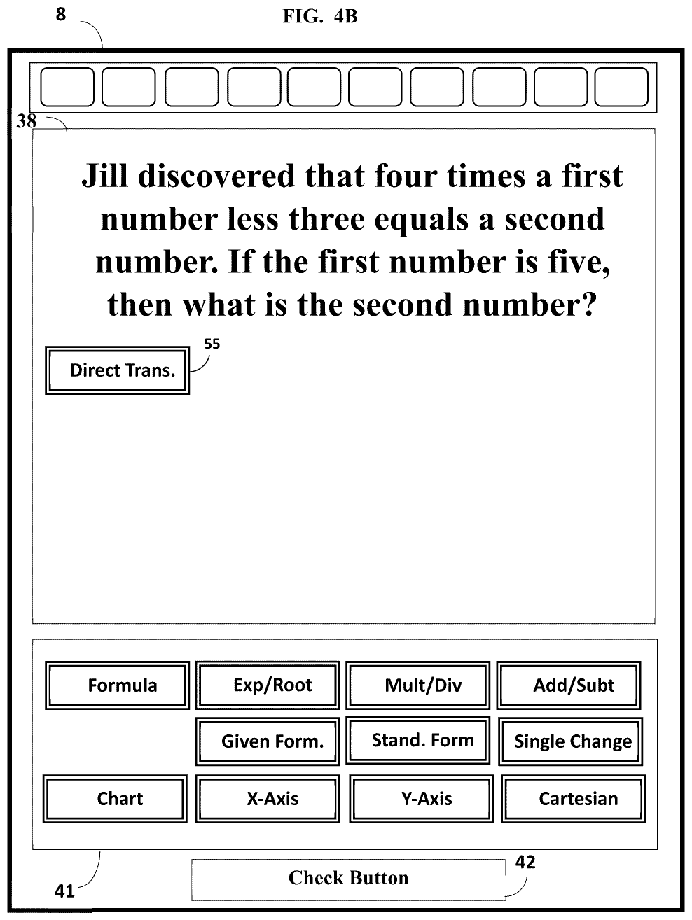

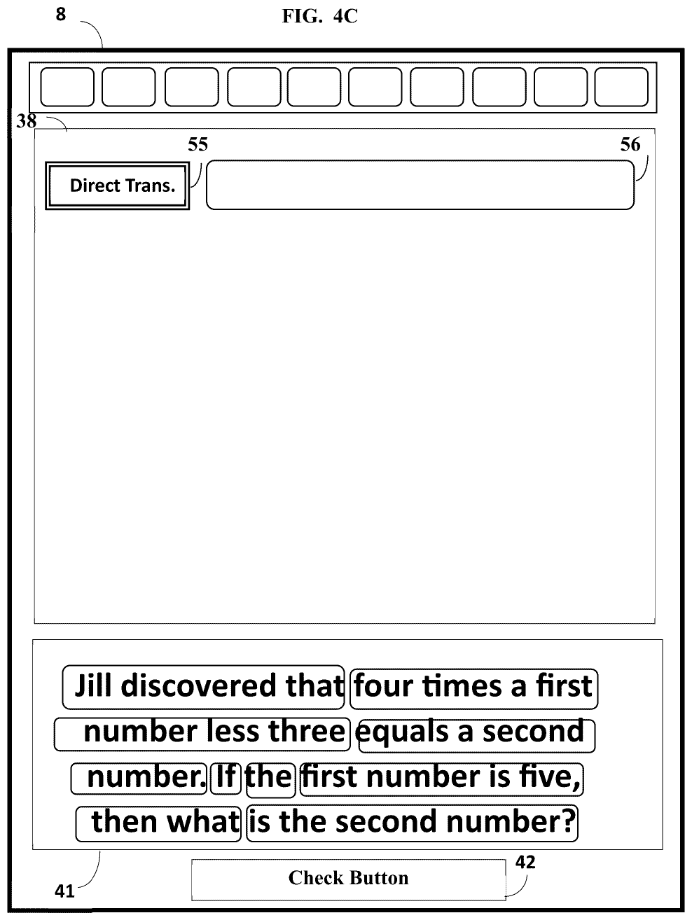

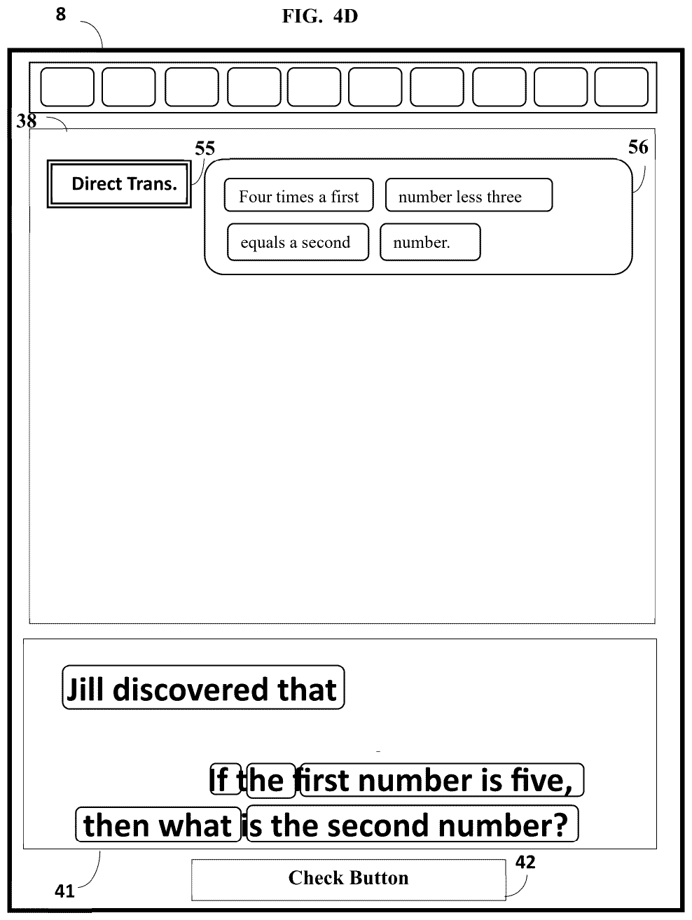

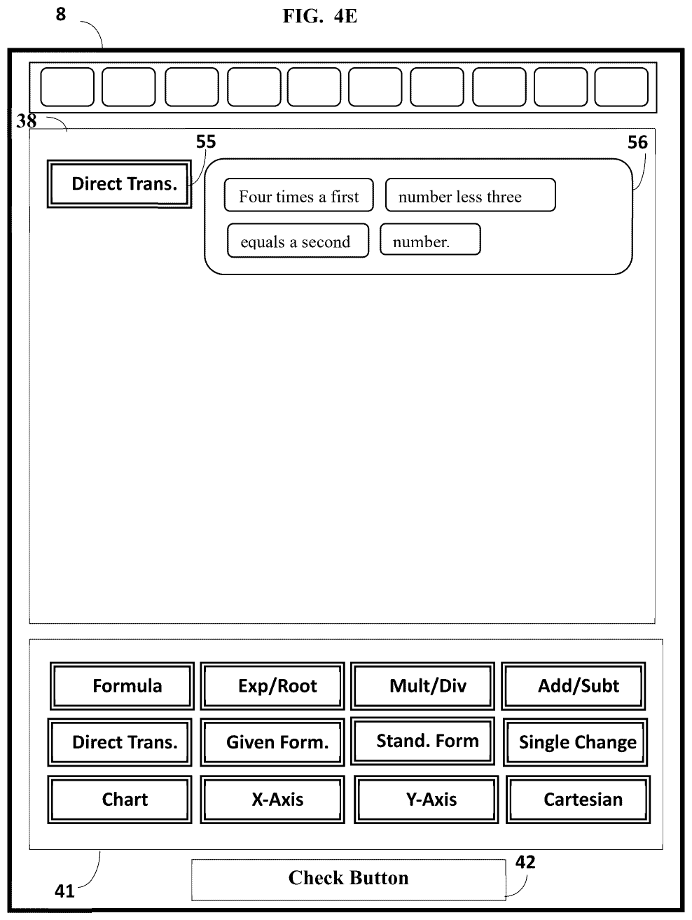

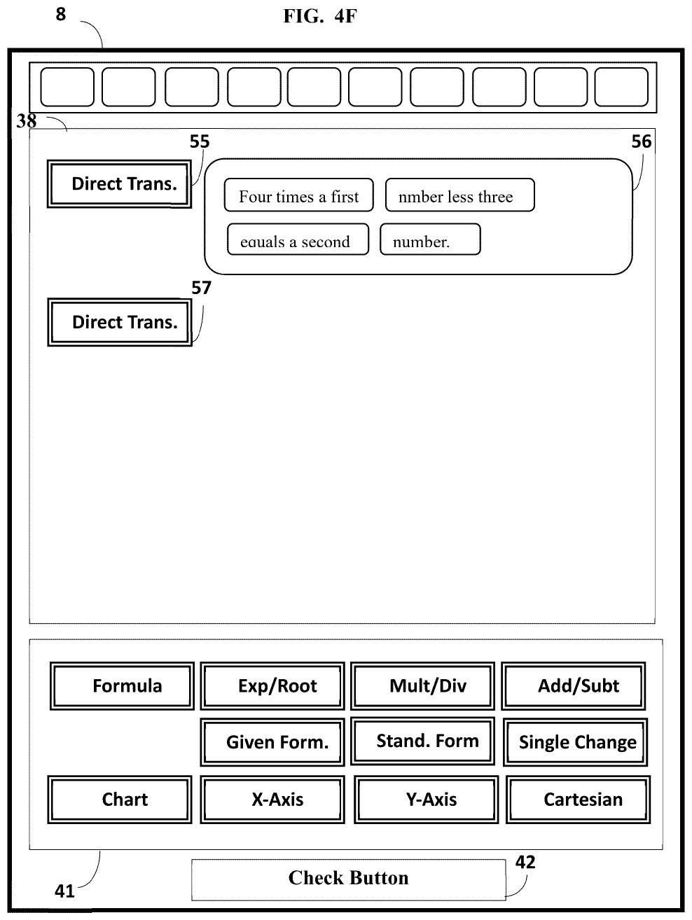

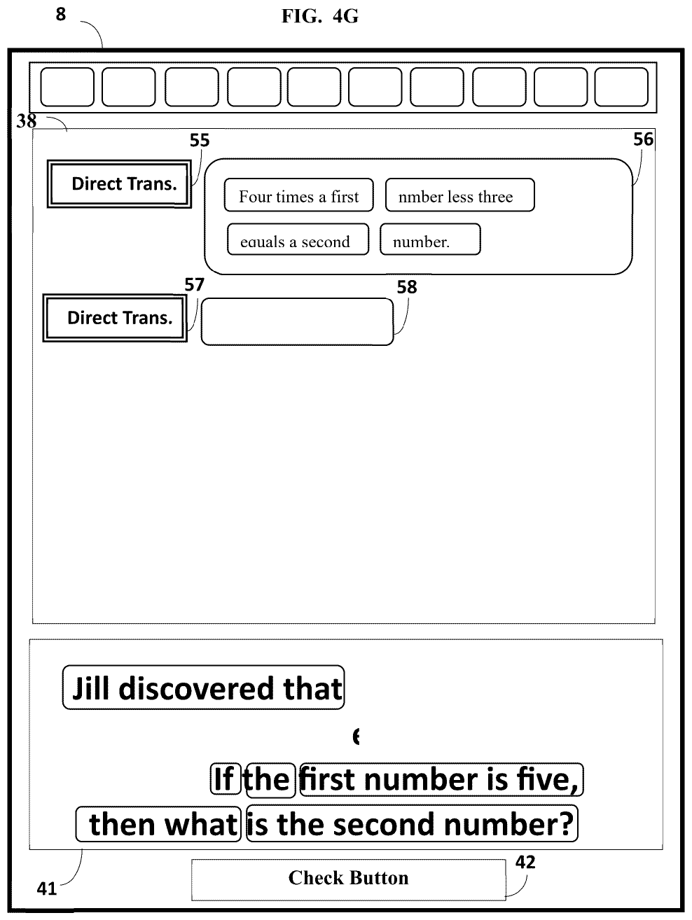

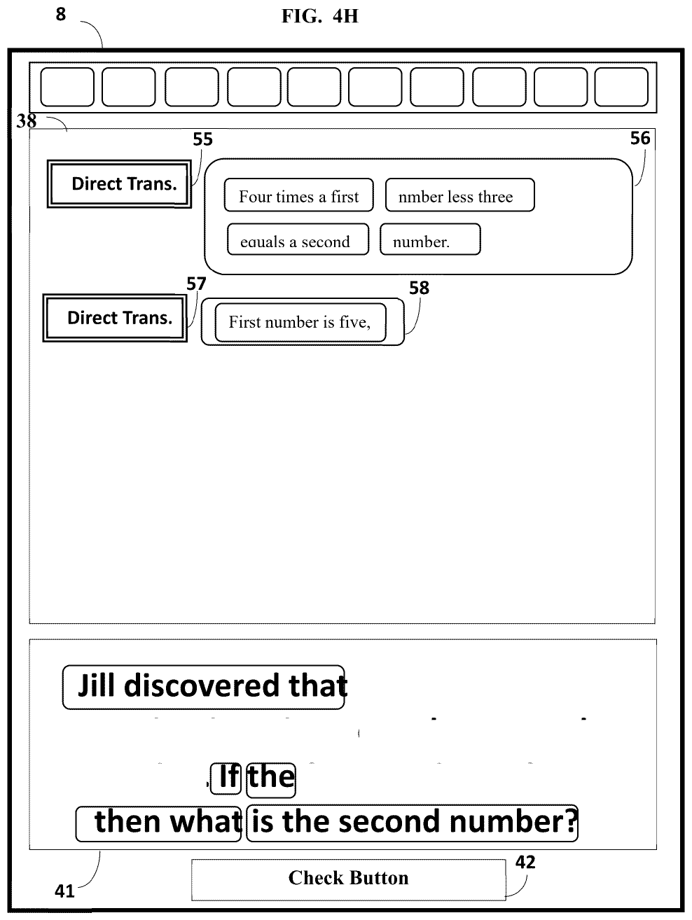

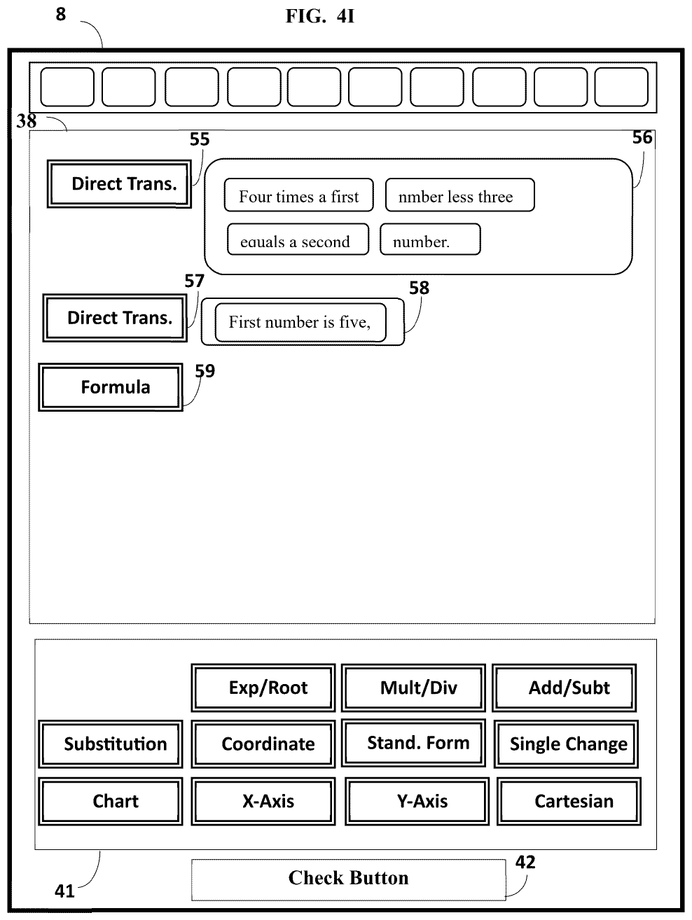

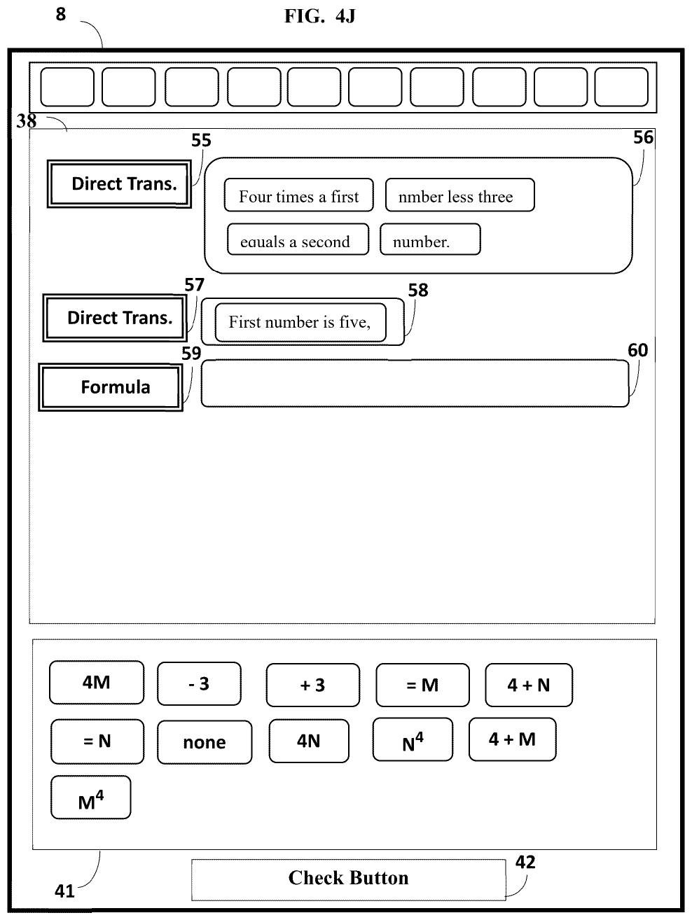

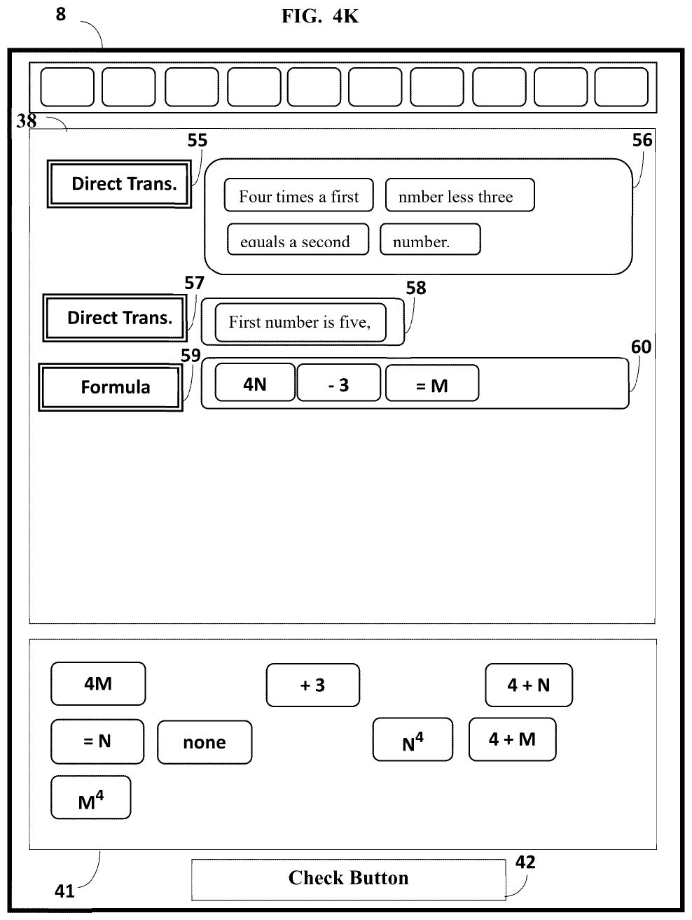

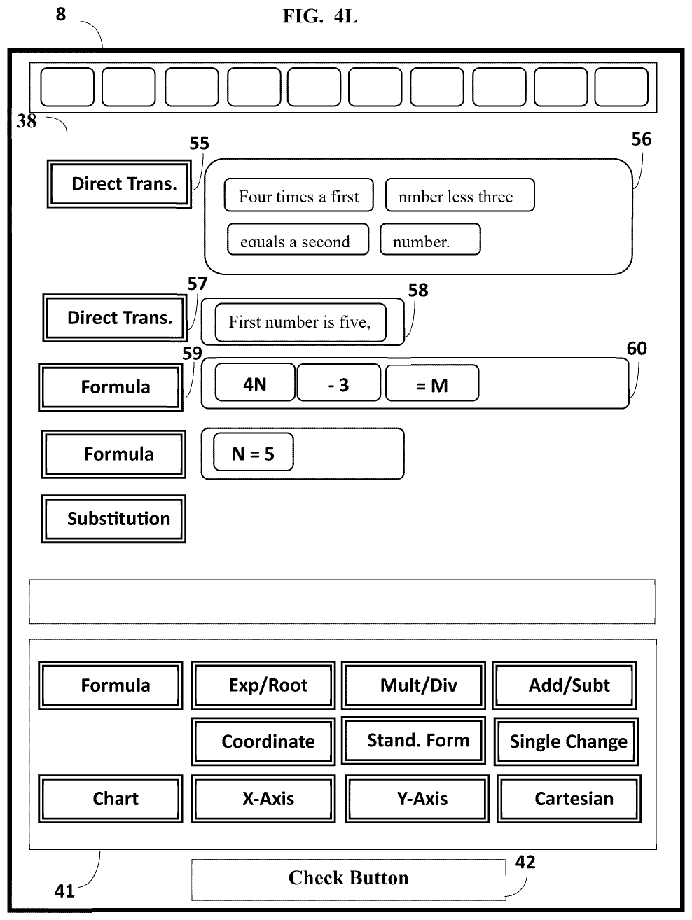

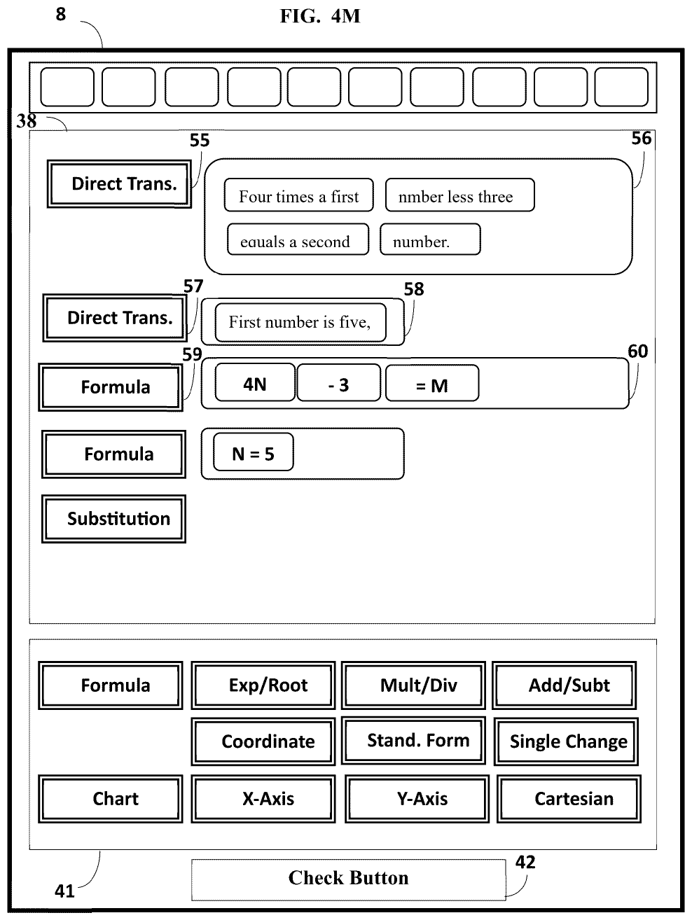

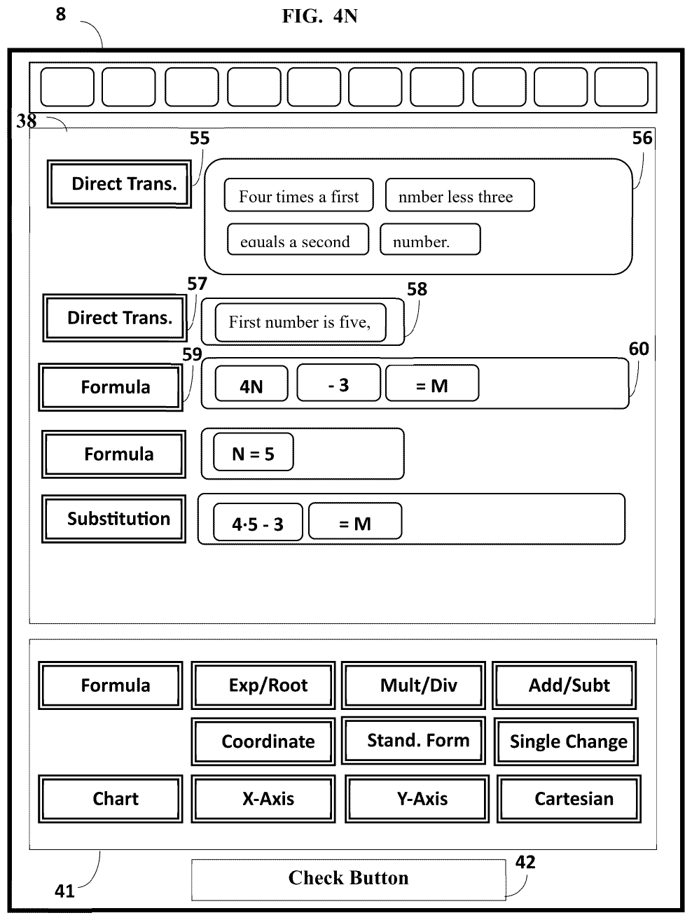

The ability of some preferred embodiments of this system to limit typing or unnecessary text selections in tight spaces becomes even more apparent when word problems are encountered, as in FIG. 4A. In the case of an embodiment that involves word problems, the blocks that appear in the first large-scale step can include blocks that allow the user to identify the type of word problem they are dealing with.

In the example illustrated by FIG. 4A, the user is dealing with a direct-translation problem. Problems of this type are so named because a portion of the verbiage in this example will translate directly into a mathematical sentence. So, the first large-scale step of this problem can be completed by dragging in a “Direct Translation” block 55 of FIG. 4B and then pressing the check button 42, as in FIG. 4C.

In some embodiments, the word problem in the workspace will disappear from the workspace and be replaced by an answer-entry-area 56, as in FIG. 4C. This sets up the second, large-scale step of the system's alternating two-step process. In a preferred embodiment of this system, the draggable-elements section 41 of FIG. 4C will be repopulated with the word problem broken into numerous draggable blocks. Some blocks are unimportant in constructing a correct answer for this step, like the one containing the phrase “Jill discovered that.” Other phrase blocks, like those housing the phrases “four times a first,” “number less three,” “equals a second,” and “number” are important to constructing a correct answer in this step.

In some embodiments, important and unimportant parts of a problem can be listed as addendums to the main problem statement and stored in memory. In other embodiments, important and unimportant parts of a problem can be coded directly into the problem via textual indicators that allow coded methods to locate those important portions, separate them out, and store them in memory. In either type of embodiment, those stored elements can then be retrieved, subdivided, and displayed in the draggable-elements section 41 of FIG. 4C.

In a preferred embodiment of this system, the user can initiate work on this second large-scale step by then dragging what they believe to be the important portions of the main phrase into the newly opened answer-entry area 56 of FIG. 4D. In such an embodiment, the user can then press the check button 42 to see if the answer just constructed is correct.

If it is correct, then this will bring the system back to the first large-scale step on the next repetition of the large-scale, two-step process that typifies interactions in preferred embodiments. In preparation for this step, a preferred embodiment will repopulate the draggable-elements area 41 of FIG. 4E with a new set of one or more correct and multiple incorrect reasoning blocks.

FIGS. 4F and 4G show the beginning of the next iteration of this large-scale, two-step process as the user moves to place a new reasoning block 57 of FIG. 4F and check if that block is correct by pressing the check button 42 of FIG. 4G.

When word problems are involved, the second large-scale step of this newest iteration can proceed in multiple ways. First, the newly introduced answer-entry area 58 might be the same horizontal size as the prior answer-entry area. In preferred embodiments of this system, this next answer-entry area will be horizontally smaller in size if it is meant to hold secondary word-problem information instead of primary information.

The other notable set of embodiment variations that can take place in this portion of the workflow deals with how the draggable-elements section can be repopulated. In some embodiments, the draggable-elements section will repopulate with all the blocks from the original draggable version of the word problem, as in element 41 of FIG. 4C. But, in a preferred embodiment, the draggable-elements section will repopulate with the blocks remaining from the prior large-scale second step. In some embodiments, the spacing between the remaining blocks will not be preserved. In a preferred embodiment, the original spacing will be preserved so that all remaining blocks appear in their original places with sections where blocks were removed remaining evident due to the now-empty spacing in element 41 of FIG. 4G.

FIG. 4H illustrates how a user would fill in this new answer-entry area 58 by dragging in one or more of the phrase-filled, draggable-answer blocks to construct a correct answer.

FIGS. 41 and 4J show the beginning of a user preparing to translate the main verbal phrase contained in element 56 into an actual mathematical phrase. As is typical in an embodiment of this system, the draggable-elements section 41 is now full of the blocks necessary to construct that answer in the answer-entry area 60 of the formula block 59 in FIG. 4J. FIG. 4K shows the completion of the second half of this large-scale pattern, where the user has pulled in a number of draggable blocks to construct the correct translation of the main formula for this step in element 60.

Element 62 in FIG. 4L shows the completion of the next two-step cycle in an embodiment of this system where the user has translated the secondary phrase in item 58 by dragging a single block, checked the translation for completion, and pulled in a substitution block 63, to begin the next two-step cycle.

FIGS. 4M and 4N show the completion of two more cycles in this process that, if it were brought to its full conclusion, would proceed as in the portion of the prior example outlined in FIGS. 3A-3J.

This current example illustrates how an embodiment of this draggable-answer system can be used with mathematical reasoning blocks to allow users to handle word problems on small screens that make detailed typing difficult or on large screens used by children with learning disabilities that make typing input difficult if not impossible.

Returning to FIG. 4D, a closer examination shows that a user could have easily dragged the draggable-answer block containing the phrase “Jill discovered that” into the answer-entry-area 56. This would have constructed the phrase “Jill discovered that four times a first number less three equals a second number.” Unfortunately, when compared to either of the correct answers for this step stored in memory (longest and shortest possibilities), this main phrase would trigger an error message for being too long and including unnecessary, non-mathematical information.

Similarly, it is possible that, in FIG. 4D, the user could have a) dragged in too few blocks to construct the correct main phrase, b) dragged in a set of completely errant blocks having nothing to do with the main phrase, c) dragged in the secondary phrase instead of a construction of the main phrase, d) dragged in some blocks in the wrong order, and/or e) many other variations of wrong entries.

An embodiment of this system provides the user ample room for both correct and incorrect word-problem input. More importantly, the wrong inputs will again fall into standard, high-probability error categories capable of fitting into statistical tables like those in FIG. 6.

Table element 76 of FIG. 6 illustrates one possible embodiment of a row that keeps track of errors a user might have made while dragging in various reasoning blocks from the draggable-entry area 41 into the work area 31. Checkmarks indicate drags that were correct from the among the last twenty times a user attempted to place a reasoning block for a given problem step. Xs represent errant placements. Thus, when looking at this table a person can immediately see the relative rates of correct to incorrect block movements. This allows a user to quickly judge how well a user is mastering reasoning block selections. Skills that had not been used at that point in time would have no Xs or checkmarks as entries.

FIG. 6 also exemplifies how, in some embodiments, if an instructor were to look at a particular table row and see an excessive number of Xs, they could then click on the up arrow to expand the row, accordion style. They would then be able to see error information corresponding to each of the Xs at the head of the now-expanded row. This would allow an instructor to see error patterns, enabling them to quickly diagnose errors in understanding or computation so that those errors could be addressed, all without actually having to be present while the user is working a given problem set or without having to check over the steps in a set once the user had partially or fully completed a given problem set.

This structure will allow embodiments of this system to leverage the skill-level error-tracking systems so critical to the uniqueness and effectiveness of mathematical reasoning blocks for a) harnessing a mathematical reasoning block automated system to “understand” and offer effective, step-level advice for user errors and b) employing a reasoning block system to record those errors in a fashion that will allow teachers to see category-based patterns in those step-level errors.

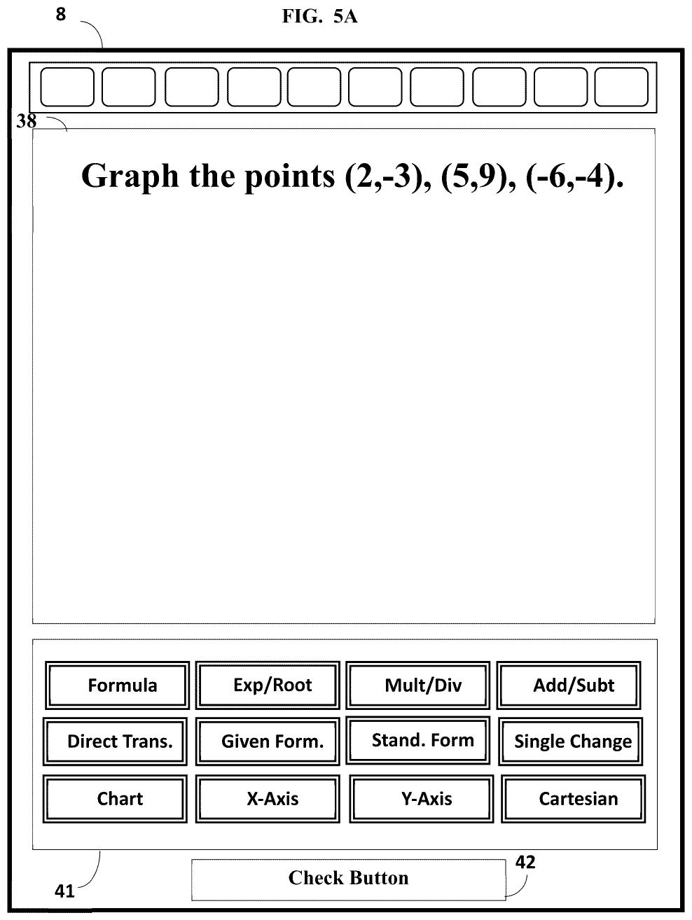

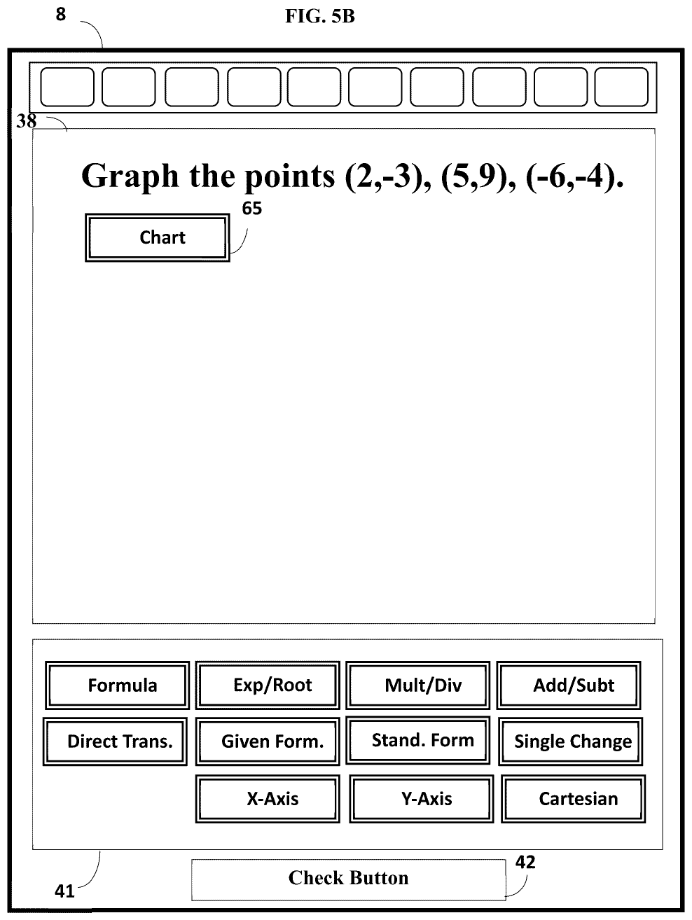

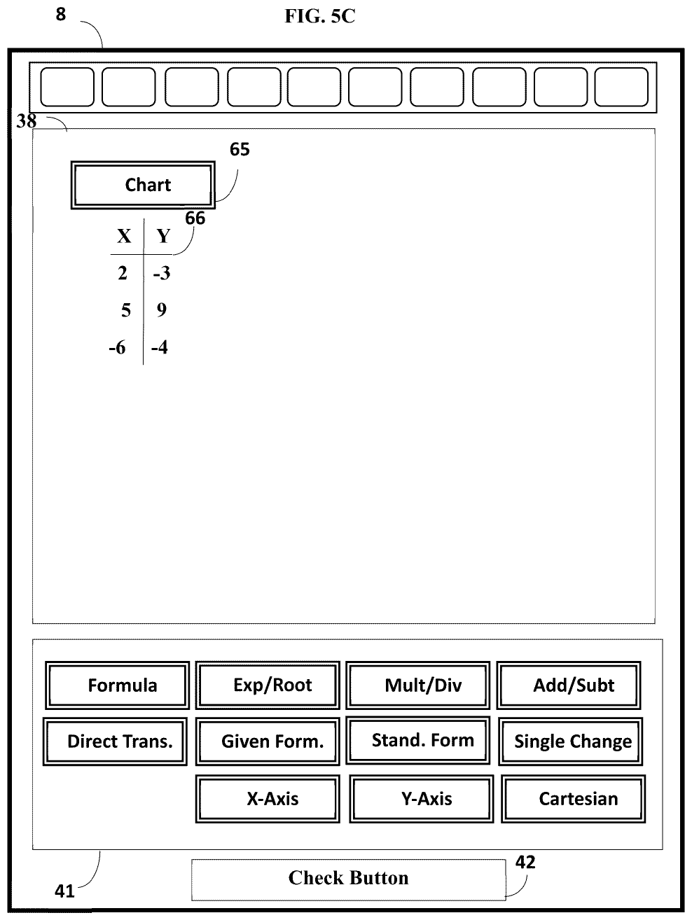

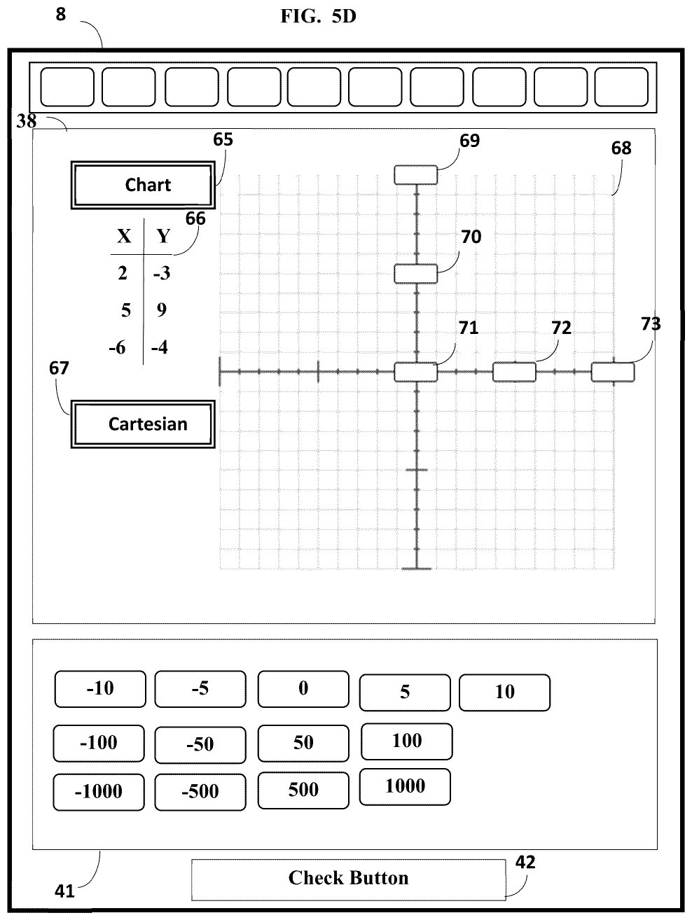

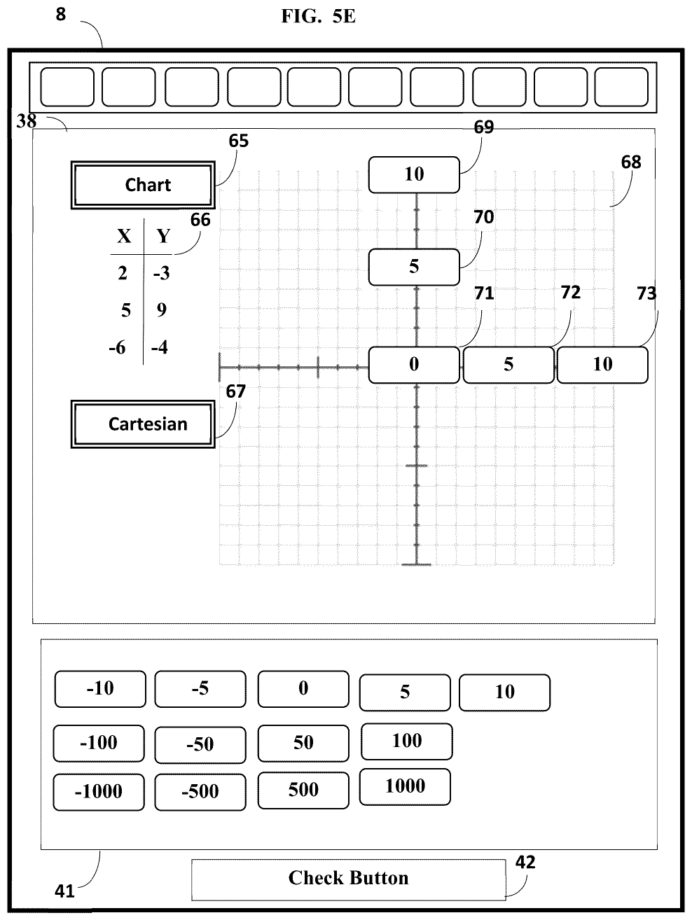

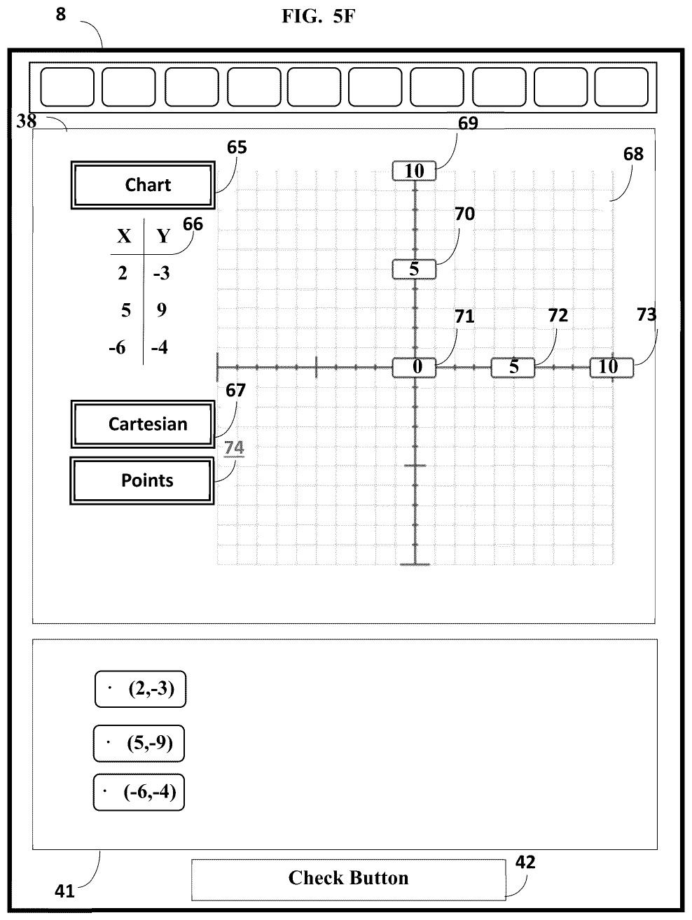

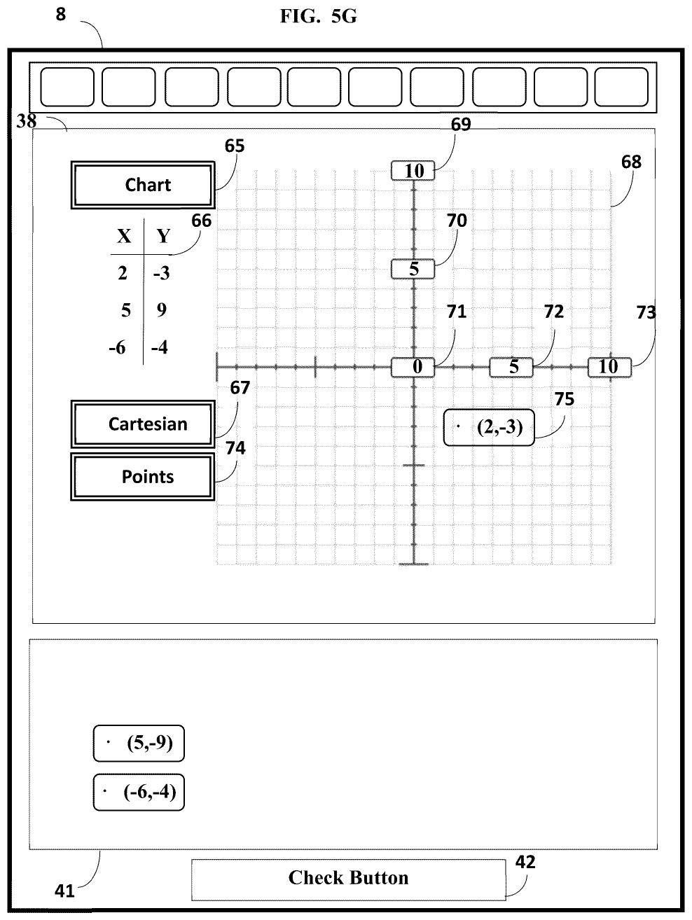

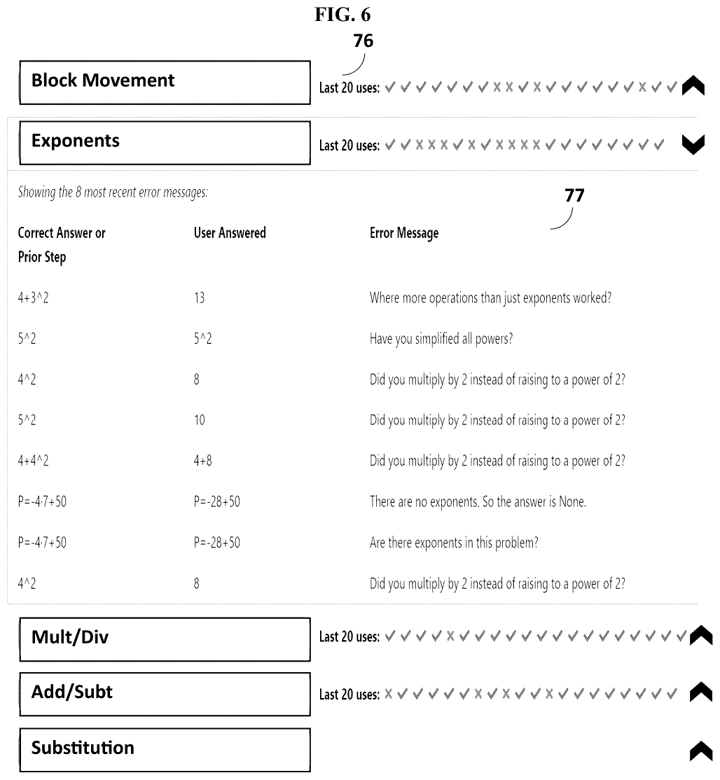

This same draggable-answer system, with minor modifications, is also useful in working with picture/graph-based math problems. In some embodiments of a system configured to handle picture-based problems, the initial problem presentation would take place in the work area 38 of FIG. 5A.

In some embodiments, not all large-scale steps in the standard two-step process (Large-Scale Step 1: steps 20-25 of FIG. 2 and Large-Scale Step 2: steps 26, 27, and 29-36 of FIG. 2) will require a draggable entry once a reasoning block has been dragged into the work area. For example, in FIG. 5B, a reasoning block 65 has been dragged into the work area. FIG. 5C demonstrates that pressing the check button 42 results in the clearing of the point graphing request, “Graph the points (2,−3), (5,9), (−6,−4)” and the introduction of a chart 66 that contains that point information, without the user having to enter that information.

This illustrates how, in some embodiments, it is not necessary to always maintain the full two-step pattern of 1) pulling in the correct draggable block, then 2) entering the correct answer in the text area of the draggable block. In some embodiments, the checking of a block may automatically provide the input that might have been completed in the second step.

FIG. 5D illustrates how some embodiments of this system can have multiple answer-entry areas 69-73 capable of receiving input.

Importantly, FIG. 5D also illustrates, once again, how the alpha-numeric-symbolic blocks that populate the draggable-answers area 41 can be selected in such a way that they provide ample leeway for users to make categorically predictable errors. For instance, in this example, we have a Cartesian graph 68. A user might drag in the correct answers to fill in each answer-entry area 69-73 of FIG. 5E. But the user could just as easily have dragged in “−10,−5,0” to fill in the Y-axis elements 69-71 of FIG. 5E, mistaking that segment of the graph for the negative portion of the X-axis. The user might also have dragged in “100,50,0,50,100”, indicating the standard error of not properly understand the need to pick a graphing scale that matches the order of magnitude of the coordinates being graphed.

FIGS. 5F and 5G illustrate how an embodiment of this system can have many types of alpha-numeric-symbolic block representations, not just verbal phrases or equational mathematical expressions. This example shows how such elements, in this case, the coordinate points now residing in the draggable blocks area 41 of FIG. 5F, can be called into being by placing the corresponding draggable block, a point block, in this case, 74 of FIG. 5F. FIG. 5G shows one of the draggable point elements 75 then being used to graph a point on the graph 68.

In other embodiments, those draggable reasoning blocks and their associated elements could represent anything from angle measures in a geometric figure to shading elements to indicate which portion or an area is being included in the graph of an inequality.

The primary consideration when coding the methods that will populate these draggable elements is that the resulting choices should always fall within standard categories of high-probability mistakes so as to ensure that the reasoning blocks' novel error-tracking abilities can be leveraged to help students correct their errors and help teachers quickly locate the error categories that characterize a particular student's misunderstanding in case the system alone is unable to help students understand and correct those errors.

In certain embodiments, the present disclosure is an apparatus for displaying sequences of problem steps corresponding to solutions to math problems for teaching each user in a group of one or more users rules for solving the math problems in a lesson comprising multiple different math problems. The apparatus comprises a visual display; a problem presentation unit configured to sequentially present math problems on the visual display to the user, wherein a correct solution for each math problem involves performance of a sequence of problem steps; one or more reasoning block units, each configured to present a sequence of reasoning blocks on the visual display for a presented math problem; and an error unit configured to (i) detect whether the user made an error in either an icon selection on the visual display or an entry on the visual display and (ii) render an indication on the visual display indicating to the user whether or not an error was detected.

Each problem step in a math problem corresponds to a math sub-skill. Each math problem involves multiple different math sub-skills. Each reasoning block in the sequence corresponds to a different problem step in the solution for the presented math problem. Each reasoning block in the sequence enables the user to make, by dragging in, a user input for a corresponding problem step. Each reasoning block unit is configured to (i) detect an incorrect user input for the math sub-skill associated with a reasoning block, (ii) determine a reason the user made the incorrect user input, and (iii) provide a mistake-specific prompt based on the determined reason for the incorrect user input. Each reasoning block is configured to display on the visual display (i) an icon selected by the user from a plurality of corresponding available icons representing the rules for solving the math problems and (ii) an entry made by the user. Each corresponding available icon on the visual display represents a type of problem step in solving math problems. Correct completion of the presented reasoning block by the user requires (i) the user to select a correct icon on the visual display for a current problem step and (ii) the user to make a correct entry for the current problem step into the presented reasoning block on the visual display.

The apparatus implements a set of rules for solving math problems by the user as follows. For each presented math problem, the apparatus (i) requires the user to try to correctly complete the current reasoning block by making the correct entry for the current problem step into the current reasoning block on the visual display and (ii) requires correct completion of the current reasoning block on the visual display before presenting a next reasoning block on the visual display. For each reasoning block, the apparatus (i) requires the user to try to select the correct icon for the current problem step on the visual display and (ii) requires selection of the correct icon for the current problem step on the visual display before enabling the user to make an entry for the current problem step into the reasoning block on the visual display. The error unit (i) keeps track of an error rate made by each user in the group for each of multiple different math sub-skills over the multiple different math problems of the lesson, each problem involving a plurality of different math sub-skills and (ii) generates statistics that characterize the user's relative performance for each of the multiple different math sub-skills for presentation immediately after the lesson is completed.

If the user selects the correct icon on the visual display for the current problem step, then the apparatus displays the correct icon in the reasoning block on the visual display for the current problem step. If the user selects an incorrect icon on the visual display for the current problem step, then the apparatus indicates to the user that the icon for the current problem step on the visual display selected by the user was incorrect. If the user makes a correct entry on the visual display for the current problem step, then the apparatus displays the correct entry in the reasoning block on the visual display for the current problem step and allows the user to proceed to the next problem step. If the user makes an incorrect entry for the current problem step on the visual display, then the apparatus prevents the user from proceeding to the next problem step.

After the user makes one or more incorrect entries on the visual display for the current problem step without making the correct entry for the current problem step on the visual display, then the apparatus provides the correct entry for the current problem step on the visual display to the user. The apparatus prevents the user from selecting an icon on the visual display for the next reasoning block for the next problem step before the current problem step is correctly completed on the visual display. The apparatus prevents the user from making an entry into the current reasoning block on the visual display for the current problem step before the correct icon on the visual display is selected for the current problem step.

The one or more reasoning block units comprise a numeric reasoning block unit configured to present a sequence of numeric reasoning blocks on the visual display for a presented free-form algebra math problem, a text reasoning block unit configured to present a sequence of text reasoning blocks on the visual display for a presented word math problem, and a graphical reasoning block unit configured to present a sequence of graphical reasoning blocks on the visual display for a presented coordinate or non-coordinate geometry math problem.

Each numeric reasoning block is configured to display (i) a numeric icon selected by the user from a plurality of available numeric icons and (ii) an alpha-numeric-symbolic entry made by the user; and each available numeric icon is an axiom, theorem, or procedural process for algebraic manipulation of a non-verbal mathematical expression in free-form algebra math problems. Each text reasoning block is configured to display (i) a text icon selected by the user from a plurality of available text icons and (ii) a text entry made by the user; and each available text icon is an axiom or definition for classification of a verbal mathematical expression in word math problems. Each graphical reasoning block is configured to display (i) a graphical icon selected by the user from a plurality of available graphical icons and (ii) a graphical entry made by the user; and each available graphical icon is an axiom, theorem, definition, or procedural concept for working with a graphical representation in geometry math problems.

For the current reasoning block, the apparatus is configured to (i) simultaneously display the plurality of corresponding available icons in a region of the visual display outside of the current reasoning block and (ii) enable the user to select one of the displayed corresponding available icons for the current reasoning block by dragging and dropping the selected icon into the current reasoning block. At least one of the corresponding available icons is a correct icon for the current problem step; and one or more others of the corresponding available icons are reasonably errant icons corresponding to different categories of likely errors. The apparatus is configured to track the different categories of likely errors for at least some of the user's selection of reasonably errant icons.

In at least some of the above embodiments, the apparatus is configured to require the correct solution of the presented math problem before presenting a next math problem.

In at least some of the above embodiments, the apparatus is configured to automatically indicate the correct icon on the visual display after the user selects an incorrect icon for the current reasoning block a specified number of times.

In at least some of the above embodiments, the apparatus is configured to require the user to select the correct icon for the current reasoning block after the apparatus automatically indicates the correct icon on the visual display.

In at least some of the above embodiments, the apparatus is configured to automatically make a correct entry for the current reasoning block, (i) after the selection of the correct icon for the current reasoning block and (ii) after the user subsequently makes a specified number of incorrect entries for the current reasoning block.

In at least some of the above embodiments, the apparatus is configured to use the tracked categories of likely errors in generating subsequent math problems for the user.

In at least some of the above embodiments, for at least one reasoning block of at least one presented math problem, the apparatus is configured to enable the user to make the entry for the reasoning block by selectively (i) typing a sequence of alpha-numeric-symbolic characters or (ii) dragging a draggable element into the reasoning block.

In at least some of the above embodiments, for at least one reasoning block of at least one presented math problem, the apparatus is configured to enable the user to make the entry for the reasoning block by dragging a graphical element from one location within the reasoning block to another location within the reasoning block.

In at least some of the above embodiments, for at least one presented math problem, the apparatus is configured to enable the user to make the entry for a current reasoning block by selecting a portion of either (i) the entry for a previous reasoning block or (ii) the presented math problem.

In at least some of the above embodiments, the apparatus is configured to enable the user to select the portion by highlighting the portion using a computer mouse.

In at least some of the above embodiments, the apparatus further comprises an instructional video unit configured to display, for a presented math problem, a video demonstrating a correct solution of the presented math problem.

In at least some of the above embodiments, the error unit is configured to generate, store, and present statistics corresponding to the user's performance in solving the presented math problems.

In at least some of the above embodiments, for a presented math problem, the apparatus is configured to simultaneously display a current reasoning block and each previous reasoning block.

In at least some of the above embodiments, for the presented math problem, the apparatus is configured to (i) simultaneously display the one or more previous reasoning blocks and the current reasoning block in a stack of reasoning blocks arranged from oldest to newest and (ii) append a next reasoning block to the end of the stack upon correct completion of the current reasoning block.

In at least some of the above embodiments, the apparatus is configured to (i) enable the user to select a math problem type for a next math problem and (ii) generate and present the next math problem corresponding to the selected math problem type.

In at least some of the above embodiments, the apparatus is configured to generate the sequentially presented math problems based on a specified difficulty level corresponding to at least one of (i) a number of reasoning blocks for a presented math problem and (ii) types of reasoning blocks for the presented math problem.

In at least some of the above embodiments, the error unit is configured to keep track of multiple, different types of math errors made by the user.

In at least some of the above embodiments, the error unit is configured to (i) keep track of the error rates for at least 13 different math sub-skills for each user in the group over the multiple different math problems of the lesson, each problem involving a plurality of different math sub-skills and (ii) generate the statistics that characterize each user's relative performance for each of the at least 13 different math sub-skills for presentation immediately after the lesson is completed.

In at least some of the above embodiments, the lesson comprises multiple different math problems for each student in a classroom of students; and the error unit is configured to (i) keep track of an error rate made by each student in the classroom for each of the at least 13 different math sub-skills over the multiple different math problems of the lesson, each problem involving a plurality of different math sub-skills and (ii) generate statistics that characterize the relative performance of each student in the classroom for each of the at least 13 different math sub-skills for presentation immediately after the lesson is completed.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. Apparatus for displaying sequences of problem steps corresponding to solutions to math problems for teaching each user in a group of one or more users rules for solving the math problems in a lesson comprising multiple different math problems, the apparatus comprising:
a visual display;
a problem presentation unit configured to sequentially present math problems on the visual display to the user, wherein a correct solution for each math problem involves performance of a sequence of problem steps;
one or more reasoning block units, each configured to present a sequence of reasoning blocks on the visual display for a presented math problem, wherein:
each problem step in a math problem corresponds to a math sub-skill;
each math problem involves multiple different math sub-skills;
each reasoning block in the sequence corresponds to a different problem step in the solution for the presented math problem;
each reasoning block in the sequence enables the user to make, by dragging in, a user input for a corresponding problem step;
each reasoning block unit is configured to (i) detect an incorrect user input for the math sub-skill associated with a reasoning block, (ii) determine a reason the user made the incorrect user input, and (iii) provide a mistake-specific prompt based on the determined reason for the incorrect user input;
each reasoning block is configured to display on the visual display (i) an icon selected by the user from a plurality of corresponding available icons representing the rules for solving the math problems and (ii) an entry made by the user;
each corresponding available icon on the visual display represents a type of problem step in solving math problems; and
correct completion of the presented reasoning block by the user requires (i) the user to select a correct icon on the visual display for a current problem step and (ii) the user to make a correct entry for the current problem step into the presented reasoning block on the visual display; and
an error unit configured to (i) detect whether the user made an error in either an icon selection on the visual display or an entry on the visual display and (ii) render an indication on the visual display indicating to the user whether or not an error was detected, wherein the apparatus implements a set of rules for solving math problems by the user as follows:
for each presented math problem, the apparatus (i) requires the user to try to correctly complete the current reasoning block by making the correct entry for the current problem step into the current reasoning block on the visual display and (ii) requires correct completion of the current reasoning block on the visual display before presenting a next reasoning block on the visual display;
for each reasoning block, the apparatus (i) requires the user to try to select the correct icon for the current problem step on the visual display and (ii) requires selection of the correct icon for the current problem step on the visual display before enabling the user to make an entry for the current problem step into the reasoning block on the visual display;
the error unit (i) keeps track of an error rate made by each user in the group for each of multiple different math sub-skills over the multiple different math problems of the lesson, each problem involving a plurality of different math sub-skills and (ii) generates statistics that characterize the user's relative performance for each of the multiple different math sub-skills for presentation immediately after the lesson is completed;
if the user selects the correct icon on the visual display for the current problem step, then the apparatus displays the correct icon in the reasoning block on the visual display for the current problem step;
if the user selects an incorrect icon on the visual display for the current problem step, then the apparatus indicates to the user that the icon for the current problem step on the visual display selected by the user was incorrect;
if the user makes a correct entry on the visual display for the current problem step, then the apparatus displays the correct entry in the reasoning block on the visual display for the current problem step and allows the user to proceed to the next problem step;
if the user makes an incorrect entry for the current problem step on the visual display, then the apparatus prevents the user from proceeding to the next problem step;
after the user makes one or more incorrect entries on the visual display for the current problem step without making the correct entry for the current problem step on the visual display, then the apparatus provides the correct entry for the current problem step on the visual display to the user;
the apparatus prevents the user from selecting an icon on the visual display for the next reasoning block for the next problem step before the current problem step is correctly completed on the visual display;
the apparatus prevents the user from making an entry into the current reasoning block on the visual display for the current problem step before the correct icon on the visual display is selected for the current problem step; and
the one or more reasoning block units comprise:
a numeric reasoning block unit configured to present a sequence of numeric reasoning blocks on the visual display for a presented free-form algebra math problem, wherein:
each numeric reasoning block is configured to display (i) a numeric icon selected by the user from a plurality of available numeric icons and (ii) an alpha-numeric-symbolic entry made by the user; and
each available numeric icon is an axiom, theorem, or procedural process for algebraic manipulation of a non-verbal mathematical expression in free-form algebra math problems;
a text reasoning block unit configured to present a sequence of text reasoning blocks on the visual display for a presented word math problem, wherein:
each text reasoning block is configured to display (i) a text icon selected by the user from a plurality of available text icons and (ii) a text entry made by the user; and
each available text icon is an axiom or definition for classification of a verbal mathematical expression in word math problems;
a graphical reasoning block unit configured to present a sequence of graphical reasoning blocks on the visual display for a presented coordinate or non-coordinate geometry math problem, wherein:
each graphical reasoning block is configured to display (i) a graphical icon selected by the user from a plurality of available graphical icons and (ii) a graphical entry made by the user; and
each available graphical icon is an axiom, theorem, definition, or procedural concept for working with a graphical representation in geometry math problems;
for the current reasoning block, the apparatus is configured to (i) simultaneously display the plurality of corresponding available icons in a region of the visual display outside of the current reasoning block and (ii) enable the user to select one of the displayed corresponding available icons for the current reasoning block by dragging and dropping the selected icon into the current reasoning block;
at least one of the corresponding available icons is a correct icon for the current problem step;
one or more others of the corresponding available icons are reasonably errant icons corresponding to different categories of likely errors; and
the apparatus is configured to track the different categories of likely errors for at least some of the user's selection of reasonably errant icons.

2. The apparatus of claim 1, wherein the apparatus is configured to require the correct solution of the presented math problem before presenting a next math problem.

3. The apparatus of claim 1, wherein the apparatus is configured to automatically indicate the correct icon on the visual display after the user selects an incorrect icon for the current reasoning block a specified number of times.

4. The apparatus of claim 3, the apparatus is configured to require the user to select the correct icon for the current reasoning block after the apparatus automatically indicates the correct icon on the visual display.

5. The apparatus of claim 1, wherein the apparatus is configured to automatically make a correct entry for the current reasoning block, (i) after the selection of the correct icon for the current reasoning block and (ii) after the user subsequently makes a specified number of incorrect entries for the current reasoning block.

6. The apparatus of claim 1, wherein the apparatus is configured to use the tracked categories of likely errors in generating subsequent math problems for the user.

7. The apparatus of claim 1, wherein, for at least one reasoning block of at least one presented math problem, the apparatus is configured to enable the user to make the entry for the reasoning block by selectively (i) typing a sequence of alpha-numeric-symbolic characters or (ii) dragging a draggable element into the reasoning block.

8. The apparatus of claim 1, wherein, for at least one reasoning block of at least one presented math problem, the apparatus is configured to enable the user to make the entry for the reasoning block by dragging a graphical element from one location within the reasoning block to another location within the reasoning block.

9. The apparatus of claim 1, wherein, for at least one presented math problem, the apparatus is configured to enable the user to make the entry for a current reasoning block by selecting a portion of either (i) the entry for a previous reasoning block or (ii) the presented math problem.

10. The apparatus of claim 9, wherein the apparatus is configured to enable the user to select the portion by highlighting the portion using a computer mouse.

11. The apparatus of claim 1, further comprising an instructional video unit configured to display, for a presented math problem, a video demonstrating a correct solution of the presented math problem.

12. The apparatus of claim 1, wherein the error unit is configured to generate, store, and present statistics corresponding to the user's performance in solving the presented math problems.

13. The apparatus of claim 1, wherein, for a presented math problem, the apparatus is configured to simultaneously display a current reasoning block and each previous reasoning block.

14. The apparatus of claim 13, wherein, for the presented math problem, the apparatus is configured to (i) simultaneously display the one or more previous reasoning blocks and the current reasoning block in a stack of reasoning blocks arranged from oldest to newest and (ii) append a next reasoning block to the end of the stack upon correct completion of the current reasoning block.

15. The apparatus of claim 1, wherein the apparatus is configured to (i) enable the user to select a math problem type for a next math problem and (ii) generate and present the next math problem corresponding to the selected math problem type.

16. The apparatus of claim 1, wherein the apparatus is configured to generate the sequentially presented math problems based on a specified difficulty level corresponding to at least one of (i) a number of reasoning blocks for a presented math problem and (ii) types of reasoning blocks for the presented math problem.

17. The apparatus of claim 1, wherein the error unit is configured to keep track of multiple, different types of math errors made by the user.

18. The apparatus of claim 1, wherein the error unit is configured to (i) keep track of the error rates for at least 13 different math sub-skills for each user in the group over the multiple different math problems of the lesson, each problem involving a plurality of different math sub-skills and (ii) generate the statistics that characterize each user's relative performance for each of the at least 13 different math sub-skills for presentation immediately after the lesson is completed.

19. The apparatus of claim 18, wherein:
the lesson comprises multiple different math problems for each student in a classroom of students; and
the error unit is configured to (i) keep track of an error rate made by each student in the classroom for each of the at least 13 different math sub-skills over the multiple different math problems of the lesson, each problem involving a plurality of different math sub-skills and (ii) generate statistics that characterize the relative performance of each student in the classroom for each of the at least 13 different math sub-skills for presentation immediately after the lesson is completed.

20. The apparatus of claim 1, wherein:
the apparatus is configured to require the correct solution of the presented math problem before presenting a next math problem;
the apparatus is configured to automatically indicate the correct icon on the visual display after the user selects an incorrect icon for the current reasoning block a specified number of times;
the apparatus is configured to require the user to select the correct icon for the current reasoning block after the apparatus automatically indicates the correct icon on the visual display;
the apparatus is configured to automatically make a correct entry for the current reasoning block, (i) after the selection of the correct icon for the current reasoning block and (ii) after the user subsequently makes a specified number of incorrect entries for the current reasoning block;
the one or more reasoning block units comprise:
a numeric reasoning block unit configured to present a sequence of numeric reasoning blocks on the visual display for a presented free-form algebra math problem, wherein:
each numeric reasoning block is configured to display (i) a numeric icon selected by the user from a plurality of available numeric icons and (ii) an alpha-numeric-symbolic entry made by the user; and
each available numeric icon is an axiom, theorem, or procedural process for algebraic manipulation of a non-verbal mathematical expression in free-form algebra math problems;
a text reasoning block unit configured to present a sequence of text reasoning blocks on the visual display for a presented word math problem, wherein:
each text reasoning block is configured to display (i) a text icon selected by the user from a plurality of available text icons and (ii) a text entry made by the user; and
each available text icon is an axiom or definition for classification of a verbal mathematical expression in word math problems; and
a graphical reasoning block unit configured to present a sequence of graphical reasoning blocks on the visual display for a presented coordinate or non-coordinate geometry math problem, wherein:
each graphical reasoning block is configured to display (i) a graphical icon selected by the user from a plurality of available graphical icons and (ii) a graphical entry made by the user; and
each available graphical icon is an axiom, theorem, definition, or procedural concept for working with a graphical representation in geometry math problems;
for the current reasoning block, the apparatus is configured to (i) simultaneously display the plurality of corresponding available icons in a region of the visual display outside of the current reasoning block and (ii) enable the user to select one of the displayed corresponding available icons for the current reasoning block by dragging and dropping the selected icon into the current reasoning block;
for at least one reasoning block of at least one presented math problem, the apparatus is configured to enable the user to make the entry for the reasoning block by selectively (i) typing a sequence of alpha-numeric-symbolic characters or (ii) dragging a draggable element into the reasoning block;
for at least one reasoning block of at least one presented math problem, the apparatus is configured to enable the user to make the entry for the reasoning block by dragging a graphical element from one location within the reasoning block to another location within the reasoning block;
for at least one presented math problem, the apparatus is configured to enable the user to make the entry for a current reasoning block by selecting a portion of either (i) the entry for a previous reasoning block or (ii) the presented math problem by highlighting the portion using a computer mouse;
the apparatus further comprises an instructional video unit configured to display, for a presented math problem, a video demonstrating a correct solution of the presented math problem;
the error unit is configured to generate, store, and present statistics corresponding to the user's performance in solving the presented math problems;
for a presented math problem, the apparatus is configured to (i) simultaneously display the one or more previous reasoning blocks and the current reasoning block in a stack of reasoning blocks arranged from oldest to newest and (ii) append a next reasoning block to the end of the stack upon correct completion of the current reasoning block;
the apparatus is configured to (i) enable the user to select a math problem type for a next math problem and (ii) generate and present the next math problem corresponding to the selected math problem type;
the apparatus is configured to generate the sequentially presented math problems based on a specified difficulty level corresponding to at least one of (i) a number of reasoning blocks for a presented math problem and (ii) types of reasoning blocks for the presented math problem; and
the error unit is configured to keep track of multiple, different types of math errors made by the user.

21. A method for displaying sequences of problem steps corresponding to solutions to math problems for teaching each user in a group of one or more users rules for solving the math problems in a lesson comprising multiple different math problems, using an apparatus comprising a visual display, the method comprising:
the apparatus sequentially presenting math problems on the visual display to a user, wherein a correct solution for each math problem involves performance of a sequence of problem steps displayed on the visual display; and
for each presented math problem on the visual display:
the apparatus presenting a sequence of reasoning blocks on the visual display, wherein:
each reasoning block in the sequence corresponds to a different problem step in the solution for the presented math problem;
each reasoning block in the sequence enables the user to make, by dragging in, a user input for a corresponding problem step;
the apparatus comprises a reasoning block unit that (i) detects an incorrect user input for the math sub-skill associated with a reasoning block, (ii) determines a reason the user made the incorrect user input, and (iii) provides a mistake-specific prompt based on the determined reason for the incorrect user input;
each reasoning block is configured to display on the visual display (i) an icon selected by the user from a plurality of corresponding available icons representing the rules for solving the math problems and (ii) an entry made by the user;
correct completion by the user of the presented reasoning block requires (i) the user to select a correct icon on the visual display for a current problem step and (ii) the user to make a correct entry for the current problem step into the presented reasoning block on the visual display; and
each corresponding available icon on the visual display represents a type of problem step in solving math problems; and
the apparatus detecting whether the user made an error in either an icon selection on the visual display or an entry on the visual display;
the apparatus rendering an indication on the visual display indicating to the user whether or not an error was detected, wherein:
each problem step in a math problem corresponds to a math sub-skill; and
each math problem involves multiple different math sub-skills; and
the apparatus implements a set of rules for solving math problems by the user as follows:
for each presented math problem on the visual display, the apparatus (i) requires the user to try to correctly complete the current reasoning block on the visual display by making the correct entry for the current problem step into the current reasoning block on the visual display and (ii) requires correct completion of the current reasoning block on the visual display before presenting a next reasoning block on the visual display;
for each reasoning block on the visual display, the apparatus (i) requires the user to try to select the correct icon for the current problem step on the visual display and (ii) requires selection of the correct icon for the current problem step on the visual display before enabling the user to make an entry for the current problem step into the reasoning block on the visual display;
the error unit (i) keeps track of an error rate made by each user in the group for each of multiple different math sub-skills over the multiple different math problems of the lesson, each problem involving a plurality of different math sub-skills and (ii) generates statistics that characterize the user's relative performance for each of the multiple different math sub-skills for presentation immediately after the lesson is completed;
if the user selects the correct icon on the visual display for the current problem step, then the apparatus displays the correct icon in the reasoning block on the visual display for the current problem step;
if the user selects an incorrect icon on the visual display for the current problem step, then the apparatus indicates to the user that the icon for the current problem step on the visual display selected by the user was incorrect;
if the user makes a correct entry on the visual display for the current problem step, then the apparatus displays the correct entry in the reasoning block on the visual display for the current problem step and allows the user to proceed to the next problem step;
if the user makes an incorrect entry for the current problem step on the visual display, then the apparatus prevents the user from proceeding to the next problem step;
after the user makes one or more incorrect entries on the visual display for the current problem step without making the correct entry for the current problem step on the visual display, then the apparatus provides the correct entry for the current problem step on the visual display to the user;
the apparatus prevents the user from selecting an icon on the visual display for the next reasoning block for the next problem step before the current problem step is correctly completed on the visual display;
the apparatus prevents the user from making an entry into the current reasoning block on the visual display for the current problem step before the correct icon on the visual display is selected for the current problem step; and
the one or more reasoning block units comprise:
a numeric reasoning block unit configured to present a sequence of numeric reasoning blocks on the visual display for a presented free-form algebra math problem, wherein:
each numeric reasoning block is configured to display (i) a numeric icon selected by the user from a plurality of available numeric icons and (ii) an alpha-numeric-symbolic entry made by the user; and
each available numeric icon is an axiom, theorem, or procedural process for algebraic manipulation of a non-verbal mathematical expression in free-form algebra math problems;
a text reasoning block unit configured to present a sequence of text reasoning blocks on the visual display for a presented word math problem, wherein:
each text reasoning block is configured to display (i) a text icon selected by the user from a plurality of available text icons and (ii) a text entry made by the user; and
each available text icon is an axiom or definition for classification of a verbal mathematical expression in word math problems; and
a graphical reasoning block unit configured to present a sequence of graphical reasoning blocks on the visual display for a presented coordinate or non-coordinate geometry math problem, wherein:
each graphical reasoning block is configured to display (i) a graphical icon selected by the user from a plurality of available graphical icons and (ii) a graphical entry made by the user; and
each available graphical icon is an axiom, theorem, definition, or procedural concept for working with a graphical representation in geometry math problems.

22. A non-transitory machine-readable medium, having encoded thereon program code, wherein, when the program code is executed by an apparatus for displaying sequences of problem steps corresponding to solutions to math problems for teaching each user in a group of one or more users rules for solving the math problems in a lesson comprising multiple different math problems, the apparatus implements an apparatus-based method comprising:
the apparatus sequentially presenting math problems on the visual display to a user, wherein a correct solution for each math problem involves performance of a sequence of problem steps displayed on the visual display; and
for each presented math problem on the visual display:
the apparatus presenting a sequence of reasoning blocks on the visual display, wherein:
each reasoning block in the sequence corresponds to a different problem step in the solution for the presented math problem;
each reasoning block in the sequence enables the user to make, by dragging in, a user input for a corresponding problem step;
the apparatus comprises a reasoning block unit that (i) detects an incorrect user input for the math sub-skill associated with a reasoning block, (ii) determines a reason the user made the incorrect user input, and (iii) provides a mistake-specific prompt based on the determined reason for the incorrect user input;
each reasoning block is configured to display on the visual display (i) an icon selected by the user from a plurality of corresponding available icons representing the rules for solving the math problems and (ii) an entry made by the user;
correct completion by the user of the presented reasoning block requires (i) the user to select a correct icon on the visual display for a current problem step and (ii) the user to make a correct entry for the current problem step into the presented reasoning block on the visual display; and
each corresponding available icon on the visual display represents a type of problem step in solving math problems; and
the apparatus detecting whether the user made an error in either an icon selection on the visual display or an entry on the visual display;
the apparatus rendering an indication on the visual display indicating to the user whether or not an error was detected, wherein:
each problem step in a math problem corresponds to a math sub-skill; and
each math problem involves multiple different math sub-skills; and
the apparatus implements a set of rules for solving math problems by the user as follows:
for each presented math problem on the visual display, the apparatus (i) requires the user to try to correctly complete the current reasoning block on the visual display by making the correct entry for the current problem step into the current reasoning block on the visual display and (ii) requires correct completion of the current reasoning block on the visual display before presenting a next reasoning block on the visual display;
for each reasoning block on the visual display, the apparatus (i) requires the user to try to select the correct icon for the current problem step on the visual display and (ii) requires selection of the correct icon for the current problem step on the visual display before enabling the user to make an entry for the current problem step into the reasoning block on the visual display;
the error unit (i) keeps track of an error rate made by each user in the group for each of multiple different math sub-skills over the multiple different math problems of the lesson, each problem involving a plurality of different math sub-skills and (ii) generates statistics that characterize the user's relative performance for each of the multiple different math sub-skills for presentation immediately after the lesson is completed;
if the user selects the correct icon on the visual display for the current problem step, then the apparatus displays the correct icon in the reasoning block on the visual display for the current problem step;
if the user selects an incorrect icon on the visual display for the current problem step, then the apparatus indicates to the user that the icon for the current problem step on the visual display selected by the user was incorrect;
if the user makes a correct entry on the visual display for the current problem step, then the apparatus displays the correct entry in the reasoning block on the visual display for the current problem step and allows the user to proceed to the next problem step;
if the user makes an incorrect entry for the current problem step on the visual display, then the apparatus prevents the user from proceeding to the next problem step;
after the user makes one or more incorrect entries on the visual display for the current problem step without making the correct entry for the current problem step on the visual display, then the apparatus provides the correct entry for the current problem step on the visual display to the user;
the apparatus prevents the user from selecting an icon on the visual display for the next reasoning block for the next problem step before the current problem step is correctly completed on the visual display;
the apparatus prevents the user from making an entry into the current reasoning block on the visual display for the current problem step before the correct icon on the visual display is selected for the current problem step; and
the one or more reasoning block units comprise:
a numeric reasoning block unit configured to present a sequence of numeric reasoning blocks on the visual display for a presented free-form algebra math problem, wherein:
each numeric reasoning block is configured to display (i) a numeric icon selected by the user from a plurality of available numeric icons and (ii) an alpha-numeric-symbolic entry made by the user; and
each available numeric icon is an axiom, theorem, or procedural process for algebraic manipulation of a non-verbal mathematical expression in free-form algebra math problems;
a text reasoning block unit configured to present a sequence of text reasoning blocks on the visual display for a presented word math problem, wherein:
each text reasoning block is configured to display (i) a text icon selected by the user from a plurality of available text icons and (ii) a text entry made by the user; and
each available text icon is an axiom or definition for classification of a verbal mathematical expression in word math problems; and
a graphical reasoning block unit configured to present a sequence of graphical reasoning blocks on the visual display for a presented coordinate or non-coordinate geometry math problem, wherein:
each graphical reasoning block is configured to display (i) a graphical icon selected by the user from a plurality of available graphical icons and (ii) a graphical entry made by the user; and
each available graphical icon is an axiom, theorem, definition, or procedural concept for working with a graphical representation in geometry math problems.
